(19) United States
(12) Patent Application Publication
(10) Pub. No.: US 2025/0290791 A1
(43) Pub. Date: Sep. 18, 2025

(54) APPARATUS AND METHOD OF MANUFACTURE FOR A PLUGGABLE INTER-CHIP OPTICAL CONNECTOR

(71) Applicant: SiPhox, Inc., Burlington, MA (US)

(72) Inventors: Sarat Gundavarapu, Chelmsford, MA (US); Diedrik Rene Vermeulen, Arlington, MA (US); Kyle Preston, Guilford, CT (US); Ebrahim Al Johani, Somerville, MA (US)

(73) Assignee: SiPhox, Inc., Burlington, MA (US)

(21) Appl. No.: 19/079,377

(22) Filed: Mar. 13, 2025

Related U.S. Application Data
(60) Provisional application No. 63/564,745, filed on Mar. 13, 2024.

(51) Int. Cl. G01J 1/04; G02B 5/18

(52) U.S. Cl. CPC G01J 1/0407; G02B 5/1861

(57) ABSTRACT

An apparatus for pluggable inter-chip optical connector may include a first sub-assembly, including at least a first photonic chip, a first high tolerance grating coupler element configured to interface with at least a second photonic chip, and a first set of one or more alignment features, and a second sub-assembly including the at least a second photonic chip, wherein the at least a second photonic chip includes a sensing region, and a second set of one or more alignment features, wherein the second set of one or more alignment features are configured to plug into the first sub-assembly at the first set of one or more alignment features, wherein attaching the first sub-assembly to the second sub-assembly using the first set of alignment features and the second set of alignment features places the first high tolerance grating coupler in optical communication with the second high tolerance grating coupler.

### CROSS-REFERENCE TO RELATED APPLICATIONS

This application claims priority to Provisional Application No. 63/564,745, titled “METHODS FOR OPTICAL COUPLING, THERMAL, MECHANICAL, AND FLUIDIC INTERFACING OF PHOTONIC CHIPS WITHOUT FIBER ATTACHMENT” and filed Mar. 13, 2024, which is incorporated herein by reference in its entirety.

### FIELD OF INVENTION

The present invention generally relates to the field of integrated photonics. In particular, the present invention is directed to an apparatus and method of manufacture for a pluggable inter-chip optical connector.

### BACKGROUND

Inter-chip optical couplers are critical components in high-speed data communication, enabling efficient optical signal transfer between integrated circuits with minimal loss. Unlike traditional electrical interconnects, optical couplers require extremely precise alignment, often within sub-micron tolerances, to ensure efficient light coupling and minimize insertion loss. Factors such as misalignment, thermal expansion, and manufacturing variations can significantly impact performance, necessitating advanced packaging techniques and alignment mechanisms. Pluggable inter-chip optical couplers must balance high accuracy with case of assembly, often incorporating precision-molded connectors, micro-optical elements, or active alignment techniques.

### SUMMARY OF THE DISCLOSURE

In an aspect, an apparatus for pluggable inter-chip optical connector may include a first sub-assembly, wherein the first sub-assembly includes at least a first photonic chip, wherein the at least a first photonic chip includes an optical source, one or more photodetectors, and one or more passive optical elements, a first high tolerance grating coupler element configured to interface with at least a second photonic chip, and a first set of one or more alignment features, and a second sub-assembly, wherein the second sub-assembly includes the at least a second photonic chip, wherein the at least a second photonic chip includes a sensing region, and a second set of one or more alignment features, wherein the second set of one or more alignment features are configured to plug into the first sub-assembly at the first set of one or more alignment features, wherein attaching the first sub-assembly to the second sub-assembly using the first set of alignment features and the second set of alignment features aligns the first high tolerance grating coupler in optical communication with the second high tolerance grating coupler.

In another aspect, a method of manufacture of a pluggable inter-chip optical connector may include providing a substrate, wherein the substrate comprises a material suitable for photonic integration, applying a photoresist layer onto the surface of the substrate, wherein the photoresist is sensitive to a specific wavelength of light using in a lithography process, patterning the photoresists layer by exposing it to light through a photomask, wherein the photomask defined the geometric pattern for one or more optical components to be fabricated on the substrate, developing the exposed photoresist to reveal the underlying substrate where the photoresist was exposed to light, leaving behind a pattern that corresponds to intended optical components, etching one or more exposed areas of the substrate, using an etching process to transfer the pattern from the photoresists on the substrate, and removing remaining photoresist, leaving one or more fabricated optical components on the substrate.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an illustration of an exemplary embodiment of a pluggable inter-chip optical connector;

FIG. 2 illustrates the basic architecture of an exemplary second sub-assembly;

FIG. 3 is a frontal and side cross section of an exemplary embodiment of at least a first photonic chip encompassed in the second sub-assembly;

FIG. 4 illustrates the basic architecture of an exemplary first sub-assembly;

FIG. 5 is a frontal and side cross section of an exemplary embodiment of at least a second photonic chip encompassed in the first sub-assembly;

FIG. 6 illustrate results of combining large-aperture grating couplers with multi-layer reflectors to achieve high coupling efficiency, optimal bandwidth, and relaxed alignment tolerance;

FIG. 7A-7D illustrates several embodiments of exemplary on-chip micro-heating elements and thermal sensing elements and their relationships with temperature, power, and resistance, as well as assemblies using alignment features;

FIG. 8 is an exemplary alignment feature, specifically illustrating a beveled edge;

FIG. 9 is an exemplary alignment feature, specifically illustrating a snap-fit configuration;

FIG. 10 is a flow diagram of an exemplary method of manufacture for a pluggable inter-chip optical connector; and

FIG. 11 is a black diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to apparatuses and methods of manufacture for a pluggable inter-chip optical connector (PICOC). In an embodiment, apparatuses and methods disclosed herein achieve optical coupling using a fiber-less optic approach.

Aspects of the present disclosure can be used to achieve fiber-less optic coupling using high efficiency grating couplers. Aspects of the present disclosure can also be used to connect inputs and outputs that allow for a higher tolerance accuracy coupling. This is so, at least in part, because the high tolerance grating couplers and alignment features present on PICOC allow for a balance between alignment tolerance and coupling efficiency. This may allow for precise coupling of disposable chips that may be functionalized for biomedical or chemical uses, which reduces costs per use.

Aspects of the present disclosure allow for a PICOC and methods of manufacture. Exemplary embodiments illustrating aspects of the present disclosure are described below in the context of several specific examples.

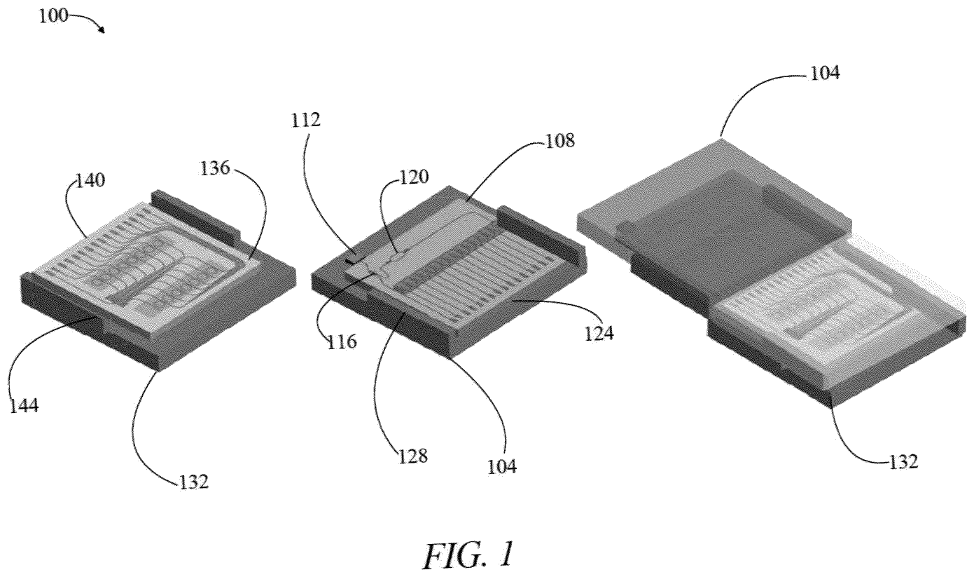

Referring now to FIG. 1, an exemplary embodiment of an apparatus 100 for a pluggable inter-chip is illustrated. In an embodiment, apparatus 100 may include a first sub-assembly 104. In an embodiment, first sub-assembly 104 may include at least a first photonic chip 108, a first high tolerance grating coupler 124 configured to interface with at least a second photonic chip 136, and a first set of one or more alignment features. For purposes of this disclosure, a “first sub-assembly” is a module responsible for converting incoming optical signals into electrical signals. For example, and without limitation first sub-assembly 104, may include components such as photodetectors for converting incoming optical signals into electrical signals, transimpedance amplifiers (TIAs) to amplify the electrical signals, optical filters for wavelength selection and/or signal conditioning, and/or coupling mechanisms to efficiently direct the optical signal to a photodetector.

In continued reference to FIG. 1, here, first sub-assembly 104 may serve as the receiving component, facilitating high-speed data transfer between chips by optical means. For example, and without limitation, first sub-assembly may include a photodetector, such as a photodiode, which converts incoming optical signals into electrical signals. Further, first sub-assembly may integrate a TIA to amplify these signals while minimizing noise and maintaining signal integrity. Additionally, in an embodiment, first sub-assembly may incorporate an optical coupling mechanism, such as a microlens array and/or fiber optic interface, which may ensure efficient light transmission into the photodetector. In an embodiment, a wavelength-specific optical filter may also be incorporated to selectively receive designated optical signals and reduce crosstalk. Moreover, signal-conditioning circuits, including equalizers and clock-data recovery (CDR) units, may enhance signal quality and timing accuracy, enabling reliable high-speed data transmission. Further, in some embodiments, first sub-assembly may leverage advanced packaging techniques, such as flip-chip bonding and/or silicon photonics integration, to minimize latency and optimize performance in high-speed interconnect applications.

With further reference to FIG. 1, in some cases, this may offer advantages over traditional electrical interconnects, including higher bandwidth and/or reduced susceptibility to electromagnetic interference. For example, optical interconnects can support significantly higher data transfer rates due to their ability to transmit signals at the speed of light with minimal signal degradation over long distances. Unlike electrical interconnects, which suffer from resistive losses, capacitance, and inductance that limit bandwidth and introduce signal attenuation, optical transmission remains largely unaffected by such constraints. Additionally, optical interconnects are inherently immune to EMI and crosstalk, which are common issues in densely packed electronic circuits, particularly at high frequencies. This immunity results in cleaner signal transmission, reducing the need for complex shielding or error correction techniques. Furthermore, optical interconnects can lower power consumption by reducing the need for high-power signal drivers and repeaters required in electrical interconnects, making them advantageous in high-performance computing, data centers, and chip-to-chip communication applications.

Continuing to reference FIG. 1, in an embodiment, first sub-assembly 104 may include at least a first photonic chip 108. As used in this disclosure, a “photonic chip,” also known as a photonic integrated circuit (PIC), is a microchip that integrates multiple photonic components to detect, generate, transport, and process light. Unlike electronic integrated circuits that use electrons to convey information, photonic chips utilize photons in the form of light that is transmitted and used in computation by means of optical elements such as gratings, waveguides, interferometers, dichroic mirrors, filters, or the like, offering advantages in speed and energy efficiency. Photonics chips may include and/or interface with one or more components that convert light signals to or from electronic signals for the purposes of integration with electronic circuitry and/or computing systems. In an embodiment, the development of photonic chips may involve various material platforms, such as indium phosphide (InP) and/or silicon photonics (SiPh). InP may allow for the integration of active and/or passive optical functions on the same chip, while SiPh may leverage existing semiconductor fabrication techniques, enabling the integration of photonic and electronic components onto a single microchip.

Still referring to FIG. 1, in an embodiment, at least a first photonic chip 108 and at least a second photonic chip 136 may be implemented, as a non-limiting example, in any manner disclosed in Attorney Docket No. 1214-024USC1, application Ser. No. 18/421,547, titled “INTEGRATED SILICON PHOTONIC BIOSENSORS FOR PLATE READERS, AND RELATED SYSTEMS AND METHODS” and filed Jan. 24, 2024, the entirety of which is hereby incorporated by reference.

In further reference to FIG. 1, in an embodiment, at least a first photonic chip 108 may include and/or connect to an optical source 112. As used throughout this disclosure, an “optical source” is a device that converts electrical signals into optical signals. This may, for example, enable the transmission of information through optical fibers or free-space channels. The primary function of an optical source 112 may include emitting light that may be modulated to carry data over various distances, depending on the application's requirements. In an embodiment, optical source 112 may include light emitting diodes (LEDs) and/or laser diodes. LEDs may emit light through spontaneous emission, resulting in incoherent light with a relatively broad spectral width. Such embodiments may be used in short-distance communication links due to their simplicity and cost-effectiveness. However, their broader spectral width may lead to higher dispersion in optical fibers or free-space channels, limiting their use in high-speed and/or long-distance applications. Alternatively, laser diodes may emit light through stimulated emission, producing coherent light with a narrow spectral width. This coherence may allow for higher output power and/or greater efficiency in coupling light into optical fibers or free-space channels.

Continuing to reference FIG. 1, in some cases optical source 112 may include a coherent light source, which is configured to emit coherent light, for example a laser. In some cases, optical source 112 may include a non-coherent light source configured to emit non-coherent light, for example a light emitting diode (LED). In some cases, optical source 112 may emit a light having substantially one wavelength. In some cases, optical source 112 may emit a light having a wavelength range. Light may have a wavelength in an ultraviolet range, a visible range, a near-infrared range, a mid-infrared range, and/or a far-infrared range. For example, in some cases light may have a wavelength within a range from about 100 nm to about 20 micronmeters. In some cases, light may have a wavelength within a range of about 400 nm to about 2,500 nm. In an embodiment, optical source 112 may include a vertical cavity semiconductor laser, a distributed feedback laser, a Vernier-tuned distributed Bragg reflector laser, and/or a coupled ring resonator laser. Additionally, optical source 112 may encompass a broader range of semiconductor and/or photonic laser sources. For example, optical source 112 may include without limitation a Fabrey Pérot (FP) laser, an external cavity laser (ECL), a quantum dot laser, a mode-locked laser, a silicon photonic integrated laser, a microdisk laser, a superluminescent diode (SLD), a ramen laser, an electrically pumped photonic crystal laser, and edge-emitting laser (EEL), a tunable laser diode (TLD), and/or the like.

With continued reference to FIG. 1, in an embodiment, at least a first photonic chip 108 may include one or more photodetectors 116. For purposes of this disclosure, a “photodetector” is a device that senses light or other electromagnetic radiation and converts it into an electrical signal. In an embodiment, one or more photodetectors 116 may include a photodiode, a photoresistor, a photosensor, a photovoltaic chip, and the like. In an embodiment, one or more photodetectors 116 may receive modulated light patterns from an optical matrix calculator and convert them into electronic signals for further processing, as a non-limiting example, in any manner disclosed in Attorney Docket No. 1214-002USU1, application Ser. No. 17/338,381, titled “METHODS AND SYSTEMS FOR OPTICAL MATRIX CALCULATION” and filed Jun. 3, 2021, the entirety of which is hereby incorporated by reference.

In some cases, photodetector may include a Germanium-based photodiode. Photodetectors may include, without limitation, Avalanche Photodiodes (APDs), Single Photon Avalanche Diodes (SPADs), Silicon Photomultipliers (SiPMs), Photo-Multiplier Tubes (PMTs), Micro-Channel Plates (MCPs), Micro Channel Plate Photomultiplier Tubes (MCP-PMTs), Indium gallium arsenide semiconductors (InGaAs), photodiodes, and/or photosensitive or photon-detecting circuit elements, semiconductors and/or transducers. Avalanche Photo Diodes (APDs), as used herein, are diodes (e.g. without limitation p-n, p-i-n, and others) reverse biased such that a single photon generated carrier can trigger a short, temporary “avalanche” of photocurrent on the order of milliamps or more caused by electrons being accelerated through a high field region of the diode and impact ionizing covalent bonds in the bulk material, these in turn triggering greater impact ionization of electron-hole pairs. APDs provide a built-in stage of gain through avalanche multiplication. When the reverse bias is less than the breakdown voltage, the gain of the APD is approximately linear. For silicon APDs this gain is on the order of 10-100. Material of APD may contribute to gains. Germanium APDs may detect infrared out to a wavelength of 1.7 micrometers. InGaAs may detect infrared out to a wavelength of 1.6 micrometers. Mercury Cadmium Telluride (HgCdTe) may detect infrared out to a wavelength of 14 micrometers. An APD reverse biased significantly above the breakdown voltage is referred to as a Single Photon Avalanche Diode, or SPAD. In this case the n-p electric field is sufficiently high to sustain an avalanche of current with a single photon, hence referred to as “Geiger mode.” This avalanche current rises rapidly (sub-nanosecond), such that detection of the avalanche current can be used to approximate the arrival time of the incident photon. The SPAD may be pulled below breakdown voltage once triggered in order to reset or quench the avalanche current before another photon may be detected, as while the avalanche current is active carriers from additional photons may have a negligible effect on the current in the diode.

In continued reference to FIG. 1, “Photodiodes,” as used herein, are semiconductor devices with a p-n junction that converts light into an electrical current. When photons are absorbed in the depletion region of the junction, electron-hole pairs are generated, resulting in a photocurrent. In an embodiment, photodiodes may include PIN photodiodes and/or avalanche photodiodes (APDs). As used throughout this disclosure, “phototransistors” provide internal amplification of the photocurrent. In some cases, phototransistors may include a light-sensitive base region, which when illuminated, may change the base current, modulating the collector current. “PMTs” are vacuum tube-based photodetectors that offer high sensitivity and fast response. PMTs may contain a photocathode that emits electrons when struck by photons. These electrons may then be multiplied through a series of dynodes, resulting in a significant amplification of the initial signal. PMTs may be utilized in applications, such as, but without limitation, requiring the detection of low light levels, such as in medical imaging and/or scientific research. For purposes of this disclosure, “CCDs” are imaging sensors composed of an array of capacitors that collect, and transfer charge generated by incident light. Such an embodiment may be utilized in applications such as digital cameras, astronomy, and/or medical imaging due to their high image quality and sensitivity. “CMOS sensors,” as used herein, integrate photodetectors 116 and signal processing circuitry on a single chip. CMOS sensors may offer advantages, such as low power consumption, high integration, and/or faster readout speeds. As used herein, “photoresistors” is a passive electronic component whose resistance decreases as the intensity of light incident upon it increases. For example, photoresistors may include intrinsic photoresistors and/or extrinsic photoresistors. In an embodiment, photoresistors may be made from semiconductor materials. “MSM photodetector” as used throughout this disclosure, is a type of photodetector characterized by its planar structure, which includes two interdigitated metal electrodes fabricated on the surface of a semiconductor material. In an embodiment, MSM photodetectors may include a semiconductor layer sandwiched between two metal electrodes.

In further reference to FIG. 1, in an embodiment, at least a first photonic chip 108 may include one or more passive optical elements 120. For purposes of this disclosure, one or more “passive optical elements” refer to components that manipulate light without requiring an external power source or active electronic control. In an embodiment, one or more passive optical elements 120 may perform functions such as splitting, combining, filtering, and/or directing optical signals solely through their inherent physical properties. Unlike active components, one or more passive optical components may not amplify and/or generate light; instead, they may manage existing light signals. In an embodiment, one or more passive optical elements 120 may include, but are not limited to waveguides, optical couplers or splitters, wavelength-division multiplexers (WDMs), optical isolators, optical circulators, optical filters, optical attenuators, optical connectors and adapters, and/or the like.

In further reference to FIG. 1, in an embodiment, optical couplers or splitters may include devices that divide an optical signal into multiple paths and/or combine signals from different fibers or free-space channels. Directional couplers may utilize waveguides placed in close proximity to enable evanescent wave coupling, allowing light to transfer between them based on phase-matching conditions. Similarly, multimode interference (MMI) couplers may exploit self-imaging effects within a multimode waveguide section to achieve controlled signal splitting or combining. Further, WDMs may include components that combine and/or separate optical signals based on their wavelengths, enabling multiple communication channels over a single fiber or free-space channel. Arrayed waveguide gratings (AWGs) may function as wavelength-selective elements by utilizing phased-array waveguides to spatially disperse different wavelengths to designated output ports. Alternatively, Mach-Zehnder interferometer (MZI)-based WDMs may leverage interference effects in paired waveguides to separate or combine spectral components dynamically.

With continued reference to FIG. 1, in an embodiment, optical isolators may include two-port devices that allow light to pass in one direction while preventing it from traveling in the reverse direction, protecting sensitive components from back reflections. Similar to isolators, but with multiple ports, optical circulators may direct light from one port to the next in a unidirectional sequence, facilitating bidirectional communication over a single fiber and/or free-space channel. Optical isolators may be implemented using Faraday rotators and polarization beam splitters, which may leverage magneto-optical effects to achieve unidirectional light transmission. Similarly, optical circulators, which are multi-port devices, may utilize similar principles to direct light sequentially from one port to the next, facilitating bidirectional communication over a single fiber or free-space channel. In an embodiment, optical filters may include components that selectively transmit and/or block specific wavelengths of light, used to manage and control the spectral properties of optical signals. Examples may include Bragg gratings, which reflect certain wavelengths while allowing others to pass, and ring resonator filters, which exploit resonance effects in mirroring waveguides to perform highly selective wavelength filtering. Optical attenuators may include devices that reduce the power level of an optical signal, used to prevent signal overload in receivers and/or to balance signal strengths in a network. Attenuation may be achieved through variable optical attenuators (VOAs), which utilize microelectromechanical systems (MEMS), liquid crystal elements, or thermally tunable waveguide structures to dynamically adjust attenuation levels. Further, optical connectors and adapters may include mechanical devices that align and join optical fibers and/or free-space channels end-to-end, ensuring minimal loss and reflection at the junctions. Grating couplers may facilitate efficient fiber-to-chip and/or chip-to-chip coupling by leveraging diffraction-based coupling mechanisms to transfer optical signals between free-space, fiber optics, and on-chip waveguides.

In an embodiment, waveguides used at optical frequencies may include dielectric waveguides, which may include structures in which a dielectric material with a relatively high permittivity, and thus a relatively high index of refraction, is at least partially surrounded by a material with a lower permittivity. Such structures may guide optical waves via total internal reflection. In certain implementations, an optical fiber may serve as an example of an optical waveguide. Other types of optical waveguides may also be utilized. For example, photonic-crystal fibers may guide optical waves using one or more distinct mechanisms. In some embodiments, guides in the form of hollow tubes having highly reflective inner surfaces may be employed as light pipes for illumination applications. The inner surface may comprise a polished metal or a multilayer film, which may guide light through Bragg reflection Additionally, in some implementations, small prisms may be positioned around the pipe to reflect light via total internal reflection. However, such confinement may be imperfect, as total internal reflection may not fully guide light within a lower-index core. In certain configurations, light may partially leak at the prism corners or other transition regions.

In further reference to FIG. 1, in an embodiment, first sub-assembly 104 may include a first high tolerance grating coupler 124 configured to interface with at least a second photonic chip 136. For purposes of this disclosure, a “grating coupler” is an optical device used to couple two optical circuits and/or elements together by way of an optical grating. For example, such as, without limitation, a diffraction grating. In an embodiment, a diffraction grating may be implemented as an optical component designed to manipulate and control the propagation of light by utilizing periodic structures that cause diffraction. Diffraction gratings may be used in optical systems for wavelength filtering, beam steering, and/or spectral dispersion in various photonic and optoelectronic applications. Various types of diffraction gratings may be utilized, each offering distinct advantages based on their fabrication method, structural design, and operational characteristics. Ruled gratings may be mechanically manufactured by precisely etching parallel grooves onto a reflective or transmissive substrate. The groove density and depth may influence the dispersion properties and diffraction efficiency. These gratings can also be blazed, meaning they are designed with a sawtooth groove profile to maximize efficiency for a particular diffraction order at a specified wavelength. Holographic gratings, in contrast, may be fabricated using laser interference lithography, producing a smooth sinusoidal groove pattern that reduces stray light, making them ideal for spectroscopy and high-precision optical applications. Volume phase holographic (VPH) gratings may employ a periodic modulation of refractive index within a photosensitive material, allowing for high diffraction efficiency and low scatter, making them particularly useful in imaging and laser applications. For high-dispersion applications, Echelle gratings may be optimized to operate at high diffraction orders, significantly enhancing spectral resolution. These gratings are often used in astronomical spectrographs and high-performance optical instruments. Binary and multilevel gratings, fabricated using lithographic processes, create discrete step approximations of continuous diffraction patterns, improving manufacturability and efficiency for integration into silicon photonics. Additionally, Bragg gratings, including Distributed Bragg Reflectors (DBRs) and Fiber Bragg Gratings (FBGs), may use alternating high-and low-refractive index layers to reflect specific wavelengths of light. These gratings may be employed in laser cavities, optical filtering, and sensing applications due to their precise wavelength selectivity and reflection characteristics.

In further reference to FIG. 1, in an embodiment, the performance of a diffraction grating may be dependent on its design parameters and tolerances. The groove density may range from 100 grooves per millimeter (g/mm) to 2000 g/mm, with a fabrication tolerance of ±0.1%, affecting spectral dispersion and resolution. The blaze angle, which may optimize efficiency for a given wavelength, may be precisely controlled within ±0.5 degrees to ensure minimal energy loss. In applications requiring high fidelity, the etch depth variability may be maintained within ±10 nm to prevent undesired phase shifts and/or diffraction anomalies. Some high-tolerance gratings are designed to accommodate misalignments of ±50 μm or greater, allowing for relaxed assembly constraints while maintaining performance. Additionally, for high-performance diffraction gratings, surface roughness may be controlled to sub-nanometer levels to reduce scattering losses and maintain high diffraction efficiency.

Continuing to reference FIG. 1, a grating coupler may be used, in non-limiting examples, to couple light between two or more elements such as an optical fiber or free-space channel and an integrated photonic circuit and/or elements thereof. The term “high tolerance” in this context, refers to the grating coupler's ability to maintain optimal performance despite variations in fabrication processes or alignment during assembly; in other words, capable of performance under relatively loose tolerances. In an embodiment, high tolerance grating couplers may be designed to be less sensitive to such deviations, ensuring consistent coupling efficiency and reliable operation. In an embodiment, high tolerance grating couplers may be engineered to accommodate variations in manufacturing, such as slight deviations in feature sizes or etching depths, without significant loss in performance.

Still referring to FIG. 1, in some embodiments each grating of grating coupler may have a width of at least 12 micrometers. In some embodiments, each grating may have a width of 20 micrometers or more. Grating coupler may have a working distance of at least 200 micrometers, where “working distance” is defined as a vertical distance between gratings within which signals can be passed at attenuation levels not exceeding 10 dB; in some embodiments, grating coupler may have a working distance of 300 micrometers or more. Grating coupler may have a tolerance of more than 100 micrometers in the axial or vertical (2) direction. Grating coupler may have a tolerance of at least +/−100 micrometers of horizontal displacement, also known as x/y displacement. In some embodiments, each grating may achieve higher tolerances by using, e.g., sub-wavelength grating periods; alternatively or additionally, subwavelength period grating may be unnecessary to achieve high tolerances or higher coupling efficiency if a multilayer reflective stack and the grating is composed of silicon nitride or another lower index material rather than silicon. Any combination of the above-described features and/or dimensions of gratings, or any other features and/or dimensions described in this disclosure, may be employed in embodiments of grating coupler.

In continued reference to FIG. 1, to achieve high tolerance, grating couplers may be designed with specific structural features. For instance, employing a larger minimum feature size, such as dimensions exceeding 200 nm, can enhance fabrication tolerance by reducing sensitivity to process variations. Additionally, utilizing a single-etch process can simplify fabrication and improve reproducibility. These design considerations may contribute to a grating coupler's robustness against common manufacturing deviations. Furthermore, high tolerance grating couplers may be optimized to maintain performance despite misalignment during assembly. For example, designs that achieve a coupling efficiency of nearly 40% (−3.97 dB) have demonstrated resilience to fabrication and alignment variations, ensuring reliable operation in practical applications. By incorporating these design strategies, high tolerance grating couplers can effectively interface with various photonic components, such as second photonic chip 136, ensuring efficient and reliable optical coupling even in the presence of manufacturing and assembly variations. The present disclosure may achieve an alignment tolerance greater than 50 μm, which is significantly more relaxed compared to other data communication interconnects that typically require sub-micron alignment tolerance. In such an embodiment, the optical bandwidth may be less than 10 nm, the electrical bandwidth may be less than 10 GHZ, and the loss may be less than 10 dB.

With continued reference to FIG. 1, in an embodiment, high tolerance grating couplers may exhibit resilience to misalignment between the optical fiber or free-space channel and the coupler. This may mean that minor positional discrepancies during assembly or operation do not drastically affect the coupling efficiency. In an embodiment, design strategies to enhance tolerance of high tolerance grating coupler elements may include apodization, inverse design optimization, and/or broadband design. Apodization, for example, may include gradually varying the grating's parameters, such as duty cycle or period, which may broaden the coupling bandwidth and improve tolerance to fabrication imperfections. Further, utilizing computational optimization techniques, such as inverse design, may allow for the creation of grating couplers with improved performance metrics, including higher coupling efficiency and/or greater tolerance to fabrication variations. In some cases, designing grating couplers to operate over a wider wavelength range may mitigate effects of fabrication-induced wavelength shifts, thereby enhancing tolerance.

In continued reference to FIG. 1, in an embodiment, first sub-assembly 104 may include a first set of one or more alignment features. One or more “alignment features,” as used herein, are specialized design elements incorporated to facilitate the precise positioning of optical components relative to the photonic integrated circuit. In an embodiment, a first set of one or more alignment features may include active alignment elements and/or passive alignment elements. For example, a first set of alignment features 128 may include alignment waveguide loops or optical shunts, alignment marks, mechanical stops and guide pins, and/or the like. In an embodiment, one or more alignment features may include one or more active alignment elements. For purposes of this disclosure, “active alignment elements” refer to components or mechanisms that facilitate the dynamic positioning, adjustment, or fine-tuning of optical, electronic, or mechanical elements during alignment. These elements may function in conjunction with real-time feedback mechanisms, such as optical signal power monitoring and/or imaging-based position detection, to optimize alignment for performance improvements. Active alignment elements may require external feedback mechanisms to fine-tune positioning, which may be beneficial in high-precision optical alignment applications. For example, active alignment elements may include alignment waveguide loops and optical shunts, which may serve as test structures configured to provide feedback on alignment accuracy by detecting optical power levels during positioning. Additionally, active alignment elements may include thermal actuators, which may comprise micro-heaters integrated into waveguides to enable fine-tuned alignment adjustments via thermal expansion. In some embodiments, piezoelectric positioners may be utilized to provide nanometer-scale movement for optical coupling applications.

In further reference to FIG. 1, in an embodiment, one or more alignment features may include one or more passive alignment elements. For purposes of this disclosure, “passive alignment elements” refers to structures, features, or mechanisms designed to position optical, electrical, or mechanical components without requiring active adjustments or real-time feedback. In an embodiment, these elements may rely on precisely fabricated mechanical guides, fiducial markers, and/or self-aligning structures to achieve accurate alignment during assembly and/or operation. Passive alignment elements may be configured to guide alignment based on mechanical features and predefined tolerances, without requiring active feedback. In some embodiments, passive alignment elements may include alignment marks, which may serve as fiducial markers for visual or automated alignment verification. Additionally, passive alignment elements may include mechanical stops and guide pins, which may provide constrained and repeatable positioning. Other passive alignment elements may include tapered waveguide elements, which may be configured to facilitate optical mode transitions to improve coupling efficiency while compensating for minor misalignments. In certain embodiments, V-grooves for fiber coupling may be incorporated to provide precisely defined placements for optical fibers. Further, passive alignment elements may include ball-and-socket locators, which may provide self-centering alignment by utilizing precision-machined mating surfaces.

In an embodiment, the disclosed design may incorporate tapered elements, which may be configured to minimize insertion loss and improve optical coupling efficiency. Tapered waveguides or fiber receptacles may be particularly beneficial in applications such as those disclosed here within, where direct chip-to-chip connections may require sub-micron alignment accuracy. Additionally, mechanical stops and guide pins may be included to facilitate modular and repeatable assembly, thereby reducing reliance on active alignment techniques. These features may be fabricated using precision machining or microfabrication techniques to achieve sub-micron tolerances without requiring iterative tuning.

In certain embodiments, V-grooves for fiber alignment may be utilized. Such methodologies may include anisotropic wet etching processes to create self-aligned structures. Additionally, material selection for alignment features may be an important consideration. For example, high-precision alignment structures may be fabricated from silicon or SiO₂-based materials, which may be advantageous due to their compatibility with semiconductor manufacturing processes. In some embodiments, metallic inserts (e.g., Kovar or Invar) may be employed to compensate for thermal expansion, thereby improving mechanical stability across varying temperature conditions. Further, polymer-based passive elements may be incorporated in certain hybrid integration approaches, such as those utilizing thermally cured UV adhesives to secure optical components.

Continuing to reference FIG. 1, in an embodiment, engineering fits may be utilized to define how tightly, or loosely mating components interact. In photonic and optical assembly applications, selecting an appropriate fit type may be beneficial in ensuring repeatable precision while accommodating thermal expansion and mechanical tolerances. Clearance fits (e.g., slip fits, loose fits) may allow for movement between components while maintaining alignment within acceptable tolerances. For example, a clearance fit may be used in guide pin assemblies, where an optical component may require initial coarse positioning before fine-tuning. Additionally, V-grooves with passive alignment may be designed to incorporate a controlled clearance fit to allow alignment elements to settle into an optimal position prior to permanent fixation. In some embodiments, transition fits (e.g., interference fits, light press fits) may provide slight friction to maintain alignment while permitting disassembly when necessary. For instance, tapered waveguide alignments may utilize a transition fit, wherein the taper may generate a guiding force configured to center the optical mode. In further embodiments, interference fits (e.g., press fits, shrink fits, expansion fits) may be used to create a permanent or semi-permanent bond through mechanical deformation. For example, press-fit guide pins may be incorporated to ensure rigidity in alignment fixtures. Additionally, shrink-fit metallic alignment sleeves may be implemented in instances where thermal expansion differences are leveraged to achieve precise assembly alignment.

In continued reference to FIG. 1, in an embodiment, the disclosed design may incorporate a combination of passive alignment features, such as tapered elements, mechanical stops, and guide pins, which may be selected to facilitate robust and repeatable assembly processes with minimal reliance on active alignment techniques. The selection of engineering fits may be based on desired adjustability requirements, wherein clearance fits may be utilized for initial positioning, transition fits for semi-permanent alignment, and interference fits for fixed placements. In some embodiments, additional refinements to alignment methodologies may include the integration of nanoimprinted alignment marks to enhance precision, the implementation of micro-electromechanical systems (MEMS)-based actuators for dynamic fine alignment, and the application of adaptive polymer adhesives that may be post-cured to optimize alignment stability.

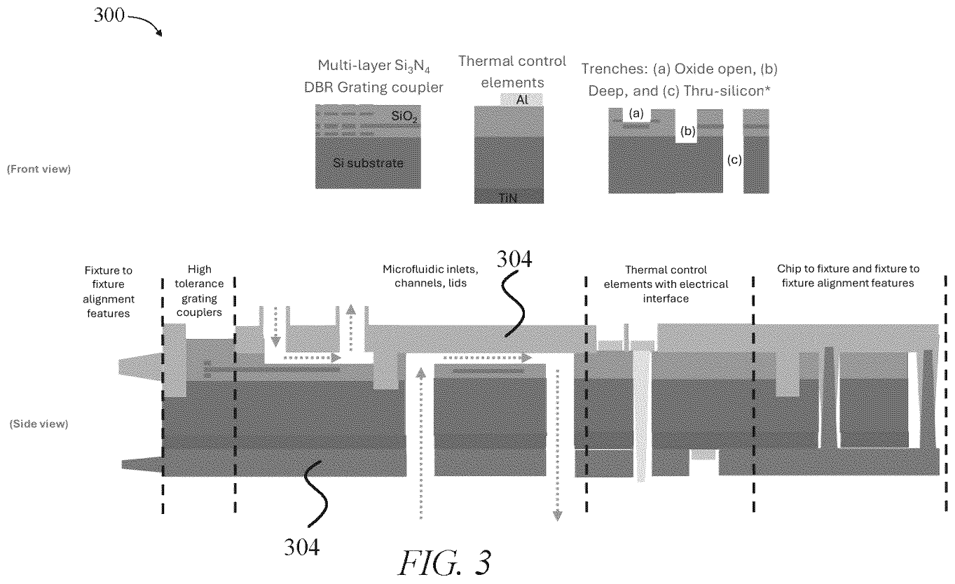

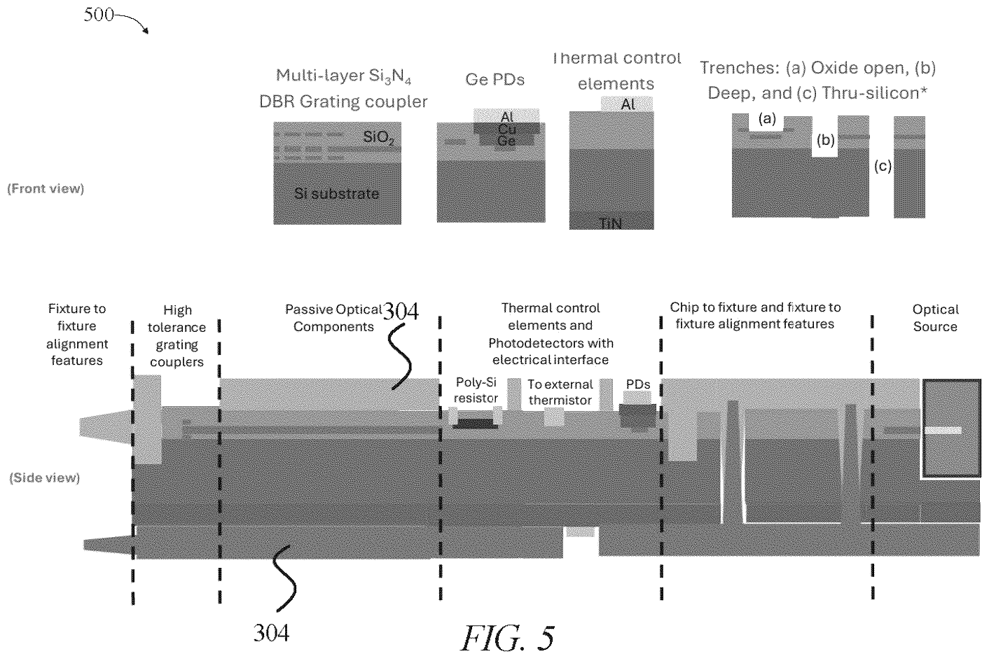

With further reference to FIG. 1, in an embodiment, first set of one or more alignment features may include one or more chip to fixture alignment features and one or more fixture to fixture alignment features. In this instance the “chip” refers to at least a photonic chip. Whereas the “fixture” refers to the supporting device of the workpiece, in this case at least a photonic chip. As used herein, one or more “chip to fixture alignment features” refer to the specialized design elements incorporated into both the chip and the fixture to ensure precise positioning and orientation during operations. These features may help mitigate errors due to mechanical tolerances, thermal expansion, and/or potential misalignment during handling. For example, and without limitation, a first set of chip to fixture alignment elements may include locating pins and holes, V-grooves and dowel pins, alignment marks, mechanical stops and guide rails, and/or the like. FIGS. 3 and 5 show (1) pins, pillars, holes, bevels etc. on the top and bottom molded fixtures, (2) partially etched and through-silicon vias (TSVs) on the chips. These features enable optical, thermal, fluidic, and mechanical interfacing of chip to fixture and fixture to fixture within and between subassemblies.

In an embodiment, precision-machined pins and corresponding holes may provide an effective alignment mechanism by ensuring that the photonic chip is correctly positioned within a mechanical fixture. These may be designed with transition fits and/or interference fits to ensure repeatability in alignment. In an embodiment, v-grooves may be etched and/or machined into a mechanical fixture to house optical fibers and/or alignment pins, ensuring a stable and repeatable placement of a photonic chip. In some cases, dowel pins may additionally be used in conjunction with v-grooves to further enhance alignment accuracy. In an embodiment, mechanical stops may be incorporated into a mechanical fixture to define the final positioning limits of a photonic chip, preventing over-travel and/or displacement. Further, guide rails may be included to provide lateral constraints, ensuring that the photonic chip remains in the intended orientation during placement. In certain embodiments, magnetic fixtures and/or vacuum-assisted holders may be employed to provide additional stability and/or alignment precision. Magnetic forces may aid in self-alignment of the photonic chip within a predefined mechanical fixture, while vacuum-based mechanisms may be used for secure placement and real-time adjustments during the alignment process. In an embodiment, chip to fixture alignment features may be particularly beneficial in pick-and-place assembly processes and/or precision bonding steps, ensuring that the photonic chip is properly aligned with waveguides, and/or external optical elements.

With further reference to FIG. 1, one or more “fixture to fixture alignment features” are specialized design elements incorporated into fixtures to ensure precise positioning and orientation relative to each other. These features may be essential when multiple fixtures are used in an assembly or testing setup, requiring repeatable positioning and minimal variation between setups. For example, and without limitation, a first set of fixture-to-fixture alignment features may include alignment pins and bushings, dowel pins, conical locators, guide rails and slots, magnetic or vacuum alignment, and/or the like.

In an embodiment, alignment pins and bushings may be used to achieve precise mechanical engagement between multiple fixtures. Hardened steel and/or ceramic bushings may be employed to ensure durability and/or minimize wear over repeated alignment cycles. In an embodiment, precision dowel pins may be used to provide repeatable alignment between fixtures. These pins may be installed in press-fit configurations to ensure stable positioning while maintaining the ability to disassemble and reassembly components without loss of alignment accuracy. In an embodiment, conical locators may include tapered guide features that allow fixtures to self-align when brought into contact. Conical locators may be used, in some cases, in conjunction with other alignment features to compensate for minor positional deviations and facilitate error-proof assembly. In an embodiment, guide rails may be incorporated to allow for linear and/or constrained movement between fixtures while maintaining precise orientation. These may be useful in test setups, assembly stations, and/or modular photonic packaging systems. In some embodiments, magnetic alignment features may be employed to automatically align fixtures relative to one another, particularly in modular and/or reconfigurable assembly stations such as the present disclosure illustrates. Vacuum-based fixture to fixture alignment may be used to provide secure and/or repeatable positioning in applications requiring high-precision optical alignment.

In various embodiments, chip-to-fixture and fixture-to-fixture alignment features may be fabricated using different materials and manufacturing techniques to enhance precision, durability, and thermal stability. For example, silicon and silica-based materials may be used in alignment structures when compatibility with photonic integrated circuits (PICs) is required. Silicon V-grooves may be etched with sub-micron precision for optical fiber alignment, while silica-based fiducial markers may be incorporated to provide high-contrast reference points for vision-based alignment. Metals, such as stainless steel, titanium, Kovar, and Invar, may be employed for alignment pins, bushings, and guide rails, providing mechanical robustness and thermal expansion control. Invar and Kovar, in particular, may be selected for their low thermal expansion properties, ensuring dimensional stability under varying temperature conditions. Additionally, ceramic-based components, such as zirconia or alumina, may be used for alignment pins, bushings, or locator features, offering high wear resistance and dimensional stability. In some embodiments, polymeric and composite materials may be utilized, especially when lightweight and cost-effective solutions are desired. Thermally cured UV adhesives may also be incorporated for permanent fixture-to-chip bonding, while flexible polymer-based locators may provide compliance in precision alignment applications. By selecting appropriate materials and alignment techniques, these alignment features may facilitate high-precision photonic assembly, ensuring repeatability and reliability in applications such as optical fiber packaging, hybrid photonic integration, and automated photonic testing systems.

In continued reference to FIG. 1, in an embodiment, first set of one or more alignment features may include one or more trenches, one or more holes, and/or one or more recesses. In an embodiment, one or more trenches may include one or more oxide open trenches, one or more deep trenches, and/or one or more thru silicon trenches. For purposes of this disclosure, one or more “trenches” are deliberate, etched structures within the semiconductor material. One or more trenches may be designed to serve various functional purposes, one of which may include alignment. In an embodiment, one or more trenches may include one or more oxide open trenches, one or more deep trenches, and/or one or more thru silicon trenches. As used herein, one or more “oxide open trenches” refer to etched grooves or trenches in the silicon substrate that are either partially or entirely devoid of insulating oxide material. In an embodiment, one or more oxide open trenches may serve various purposes, this may include for example, accomplishing isolation structures and/or trench gate structures. In processes such as Shallow Trench Isolation (STI), trenches are etched into the silicon substrate and subsequently filled with silicon dioxide to electrically isolate adjacent devices, such as n-type and p-type regions in CMOS technology. The initial etching may create an open trench, which may later be filled with oxide material. In power devices such as metal-oxide-semiconductor field-effect transistors (MOSFETs), trenches may be etched into the silicon substrate to form the gate regions. These trenches may have specific oxide configurations, such as thick oxide layers at the bottom, to minimize gate capacitance and/or to improve breakdown voltage.

With further reference to FIG. 1, one or more “deep trenches,” as used herein, are narrow, vertically etched structures in the silicon substrate that extend below the oxide or silicon nitride layers, but not all the way through the silicon. One or more deep trenches may be utilized to electrically isolate adjacent circuit components, preventing unwanted electrical interfaces and/or crosstalk. Further, in some cases, one or more deep trenches may be used to form trench capacitors, allowing for increased capacitance without consuming additional surface area. In an embodiment, fabrication of one or more deep trenches may involve advanced etching processes, such as Deep Reactive-Ion Etching (DRIE). In some cases, DRIE may enable the formation of high-aspect-ratio trenches with steep sidewalls.

Continuing to reference FIG. 1, for purposes of this disclosure, one or more “silicon thru trenches” are vertical trenches that pass entirely through a silicon wafer or die. In an embodiment, one or more silicon thru trenches may enable direct communication between different layers of a three-dimensional integrated circuit. In some embodiments, but not necessarily all, silicon thru trenches may include electrical connections, wherein when they are fabricated, they are etched into the silicon substrate and then filled with a conductive material, such as copper, to establish electrical pathways. These electrical connections may serve various functional purposes within an integrated photonic or microelectromechanical system (MEMS). For instance, they may provide electrical power to embedded heating elements used for active optical alignment, thermal tuning of waveguides, and/or temperature stabilization in photonic circuits. Additionally, these electrical pathways may be used to transmit signals to integrated sensors, such as photodetectors for optical power monitoring and/or thermal sensors for temperature compensation. In certain implementations, the thru trenches may also facilitate grounding and electromagnetic shielding, minimizing electrical noise and interference within high-frequency or high-sensitivity applications. Furthermore, these conductive pathways may enable high-density electrical interconnections in multi-layered photonic packaging, providing a means for efficient signal routing between different functional layers of a photonic or MEMS device. By integrating electrical connections within silicon thru trenches, these embodiments may enhance the functionality and performance of advanced photonic, sensing, and microelectronic systems.

With continued reference to FIG. 1, for purposes of this disclosure, one or more “recesses” refer to deliberate, structured indentations, depressions, or cavities formed within the substrate, semiconductor material, or device layer. In an embodiment, one or more recesses may be configured to facilitate optical coupling by providing a structured alignment interface for optical components, such as optical fibers, waveguides, photonic integrated circuits (PICs), or micro-optical elements. These recesses may be precisely etched into a substrate or device layer to accommodate optical elements, ensuring accurate positioning for efficient light transmission. By incorporating recesses with well-defined depths and geometries, optical alignment precision may be improved, thereby reducing insertion loss and improving signal integrity. In certain implementations, recesses may function as passive alignment features, wherein an optical fiber or waveguide may be seated within the recess to achieve precise lateral and vertical positioning relative to an optical emitter, detector, or adjacent waveguide structure. For example, V-grooves or U-shaped recesses may be formed in a silicon photonic substrate to guide optical fibers into an optimal coupling position with on-chip waveguides. In some embodiments, these recesses may be coated with anti-reflective materials, metal coatings, or index-matching layers to further enhance optical efficiency. Additionally, recesses may be engineered to support hybrid integration of optical elements, such as grating couplers or microlenses, to facilitate efficient light coupling between free-space optical components and integrated photonic circuits. By leveraging precisely fabricated recesses for optical coupling, complex optical alignment procedures may be simplified, allowing for high-precision and scalable manufacturing of photonic devices. These recesses may be fabricated using deep reactive ion etching (DRIE), laser micromachining, or wet etching processes, depending on the desired depth, width, and integration requirements. In some embodiments, recesses may also serve as thermal management features, enabling efficient dissipation of heat generated by high-power optical components, thereby improving overall device performance and longevity.

In further reference to FIG. 1, in an embodiment, apparatus 100 may further include a second sub-assembly 132, wherein the second sub-assembly 132 includes the at least a second photonic chip 136, wherein the at least a second photonic chip 136 includes a sensing region, a second high tolerance grating coupler 140 configured to interface with the at least a first photonic chip 108, and a second set of one or more alignment features, wherein the second set of one or more alignment features are configured to plug into the first sub-assembly 104 at the first set of one or more alignment features, wherein attaching the first sub-assembly 104 to the second sub-assembly 132 using the first set of alignment features 128 and the second set of alignment features 144 places the first high tolerance grating coupler 124 in optical communication with the second high tolerance grating coupler 140. For purposes of this disclosure, “optical communication” refers to the transmission of an optical signal from one component to another, wherein the emitted optical signal from a first component is aligned and received by a second component. Optical communication may involve the propagation of light through free space, optical waveguides, fiber optics, or other photonic structures, with the goal of maintaining signal integrity while minimizing optical loss, scattering, or mode mismatch. In some embodiments, optical communication may occur with direct coupling, where the light source is precisely aligned with the receiving element, or with indirect coupling, where intermediary optical elements, such as lenses, mirrors, or beam splitters, may be used to guide the signal. It may be understood that during optical communication, some degree of signal attenuation or distortion may occur, depending on factors such as material properties, coupling efficiency, alignment precision, and environmental conditions. Optical transmission may be optimized through the use of anti-reflective coatings, mode-matching structures, or high-precision alignment features to minimize loss and enhance signal fidelity. In certain implementations, feedback mechanisms or active alignment techniques may be used to correct misalignment and maximize optical power transfer.

With continued reference to FIG. 1, in an embodiment, second sub-assembly 132 may include at least a second photonic chip 136, a second high tolerance grating coupler 140 and a second set of one or more alignment features. For purposes of this disclosure, a “second sub-assembly” refers to a pre-assembled module designed to facilitate the alignment and integration of optical components. In an embodiment, second sub-assembly 132 may include various optical elements, alignment features, and mechanical housing. In an embodiment, the mechanical housing may include a robust enclosure configured to protect the internal components and provide interfaces for integration into a larger system. In an embodiment, second sub-assembly 132 may be utilized to align lasers and photodetectors 116 with waveguides or other optical pathways without relying on fiber interconnections. By utilizing second sub-assembly 132 in fiber-less optical coupling, manufactures may achieve a more compact, efficient, and reliable optical system, by minimizing the complexities and potential losses associated with traditional fiber optic cabling.

With further reference to FIG. 1, in an embodiment, second sub-assembly 132 may include at least a second photonic chip 136, wherein at least a second photonic chip 136 includes a sensing region. For purposes of this disclosure, a “sensing region” refers to the specific area or volume within an optical system where light interacts with the target medium or analyte. For example, sensing region of at least a second photonic chip 136 may include one or more on-chip photonic sensors. As used herein, one or more “on-chip photonic sensors” are a miniaturized device that integrates photonic components on a single microchip to detect and measure various physical, chemical, or biological parameters. Utilizing light instead of electrical signals, one or more on-chip photonic sensors may leverage the principles of photonics to achieve high sensitivity, rapid response times, and/or compact form factors. In an embodiment, on-chip photonic sensors and the functionalization of such may be implemented, as a non-limiting example, in any manner disclosed in Attorney Docket No. 1214-001USU1, U.S. Pat. No. 11,891,643, titled “METHODS AND SYSTEMS FOR MONOMER CHAIN FORMATION” and filed Jun. 3, 2021, the entirety of which is hereby incorporated by reference.

In some embodiments, at least a second photonic chip 136 may include additional structures and functional elements that support the sensing process, even when the primary detection mechanism is located on a separate reader or first sub-assembly 104. For example, at least a second photonic chip 136 may include specialized surfaces, reservoirs, microfluidic passages, optical waveguides, or coatings designed to facilitate interaction between the photonic signals and the target analyte. These features may influence the photonic signal by modulating its phase, intensity, or spectral characteristics, thereby enabling detection by a remote or integrated sensor. The surfaces of the sensing region may also be functionalized with biorecognition elements (e.g., antibodies, aptamers, or molecular imprints) to selectively capture target biomolecules or analytes, which, in turn, affect the optical properties of the system. In further reference to FIG. 1, in an embodiment, sensing region of at least a second photonic chip 136 may be functionalized for chemical and/or biomedical sensing requirements. By modifying the surface properties of sensing region, apparatus 100 may achieve high sensitivity and selectivity for target analytes. Such an embodiment may be used for biomedical sensing and/or chemical detection. Functionalized optical sensors may be employed in detecting biomarkers, monitoring glucose levels, and/or other diagnostic applications. The specificity provided by surface functionalization may enable accurate and real-time monitoring of physiological parameters. In chemical sensing, functionalized regions may detect various analytes, including gases, ions, and/or organic compounds. The choice of functionalization may determine the selectivity and sensitivity of the sensor to specific chemical species. In an embodiment, functionalization strategies may include, but are not limited to, surface plasmon resonance (SPR), nanoparticle coatings, and/or hydrogel incorporation. In SPR-based sensors, the sensing region may be functionalized with a biorecognition element, such as antibodies or nucleic acids, to selectively bind target molecules. This binding may change the refractive index near the sensor surface, which may be detected optically. Further, in some embodiments, applying coatings of nanoparticles, such as gold or silica, to the sensing region may enhance sensitivity. For example, nanoparticles may be used to exploit localized surface plasmon resonance (LSPR), providing real-time analysis of light-matter interactions. In some embodiments, hydrogels may be integrated into the sensing region, allowing for the immobilization of enzymes and/or other reactive agents. This approach may be beneficial for detecting specific biochemical interactions, such as glucose monitoring, where the hydrogel may swell or shrink in response to analyte concentration changes, altering the optical properties of the sensor.

In some embodiments, the second photonic chip 136 may be designed as a disposable chip, allowing for single-use applications in scenarios where sample contamination or biohazard risks need to be minimized. This disposable nature may also facilitate cost-effective deployment of photonic sensing technology in point-of-care diagnostics, environmental monitoring, and chemical detection.

In continued reference to FIG. 1, in an embodiment, a microfluidic channel connection may be incorporated into the second photonic chip 136, enabling precise control of fluid flow across the sensing region. The microfluidic channels may be used to deliver liquid samples, buffer solutions, or reagents to the sensing region in a controlled manner. Such a microfluidic interface may be aligned and connected via the reader using the same chip-to-fixture alignment features described earlier, such as guide pins, mechanical stops, or V-grooves. Alternatively, the microfluidic connection may be established through a separate interface, such as an external reservoir, capillary tubes, or an integrated pump system. In some cases, the microfluidic channels may be fabricated using soft lithography, injection molding, or laser ablation techniques, depending on the required precision, material properties, and fluidic handling characteristics. By incorporating a combination of microfluidics, optical waveguides, and alignment features, the second photonic chip 136 may facilitate highly sensitive, repeatable, and automated photonic sensing while enabling seamless integration with external or on-chip photonic detection systems. These design considerations may allow for the development of robust and scalable photonic biosensing platforms applicable to a wide range of industries, including biomedical diagnostics, environmental sensing, industrial process monitoring, and/or the like.

In continued reference to FIG. 1, in an embodiment, second sub-assembly 132 may include a second high tolerance grating coupler 140 configured to interface with the at least a first photonic chip 108. In an embodiment, at least a second high tolerance grating coupler 140 may include any embodiment as described in reference to at least a first high tolerance grating coupler 124. Further, in one or more embodiments, at least a first high tolerance grating coupler 124 and/or at least a second high tolerance grating coupler 140 may include a plurality of high tolerance grating couplers. For example, at least a second high tolerance grating coupler 140 may include two high tolerance grating couplers. Likewise, at least a first high tolerance grating coupler 124 may include two high tolerance grating couplers. The presence of multiple high tolerance grating couplers may enable the connection of multiple optical channels between sub-assemblies. In some embodiments, each grating coupler may correspond to a separate optical signal pathway, allowing for the transmission of distinct wavelengths or modes between the first and second photonic chips. This multi-channel configuration may be beneficial in applications requiring wavelength-division multiplexing (WDM), polarization diversity, or multimodal optical sensing, where different optical signals must be efficiently transferred between components.

Further, in some embodiments, multiple high tolerance grating couplers may be arranged to support parallel optical interconnects between the sub-assemblies, increasing data throughput in photonic computing, telecommunications, or optical signal processing applications. These couplers may be strategically positioned to align with corresponding optical waveguides, ensuring precise and efficient light transfer. Additionally, the alignment of multiple grating couplers may be facilitated using passive alignment features, such as V-grooves, fiducial markers, or mechanical guide rails, to ensure repeatable and high-precision coupling between photonic chips. In certain implementations, the grating couplers may also be designed to interface with free-space optical elements, fiber arrays, or micro-optics, further expanding the versatility of the optical interconnects. For example, in some embodiments, free-space coupling may be used to bridge optical signals between chips in a non-contact configuration, allowing for greater flexibility in modular photonic systems. By incorporating multiple high tolerance grating couplers into both the first and second sub-assemblies, the system may support multi-channel optical communication, enabling advanced functionality such as spectral multiplexing, polarization diversity, bidirectional data transfer, and high-throughput optical interconnects.

With continued reference to FIG. 1, in an embodiment, second sub-assembly 132 may include a second set of one or more alignment features, wherein the second set of one or more alignment features are configured to interact with the first sub-assembly 104 at the first set of one or more alignment features, wherein attaching the first sub-assembly 104 to the second sub-assembly 132 using the first set of alignment features 128 and the second set of alignment features 144 places the first high tolerance grating coupler 124 in optical communication with the second high tolerance grating coupler 140. In an embodiment, a second set of one or more alignment features may include any embodiment as discussed in reference to first set of one or more alignment features. In an embodiment, the optical communication achieved herein may allow for minimal loss, ensuring effective optical coupling and signal integrity.

In some embodiments, the second set of alignment features may be implemented in accordance with any embodiment described in reference to the first set of alignment features. To provide a robust and adaptable alignment system, the alignment features of the first and second sub-assemblies may incorporate various male and female interlocking elements designed to ensure repeatable and high-precision positioning. In certain configurations, the first sub-assembly 104 may include male alignment elements, such as guide pins, tapered dowels, or conical locators, while the second sub-assembly 132 may include corresponding female alignment elements, such as precision-milled holes, V-grooves, or recessed sockets. Alternatively, in some embodiments, the alignment configuration may be reversed, wherein the second sub-assembly 132 includes male alignment elements, and the first sub-assembly 104 includes corresponding female alignment elements.

In additional embodiments, alignment features may be symmetrical or interchangeable, such that both sub-assemblies include complementary male and female features, enabling bidirectional compatibility and simplified manufacturing processes. For example, interlocking tapered elements may be incorporated into both sub-assemblies, wherein each alignment feature contains a receiving groove and a protruding guide, facilitating secure mating. Similarly, alignment features may include self-centering mechanisms, such as ball-and-socket joints or precision-fit conical guides, which may passively correct minor misalignments during assembly.

Further, in certain implementations, the alignment features may incorporate snap-fit, magnetic, or vacuum-assisted securing mechanisms to enhance stability. For example, a snap-fit connection may be achieved by incorporating complementary latch-and-notch elements into both sub-assemblies, allowing for a secure yet detachable coupling. Alternatively, magnetic alignment features may be used to enable non-contact or easily reconfigurable optical connections, particularly in applications requiring modular photonic components. Additionally, vacuum-based alignment techniques may be employed to temporarily hold and fine-tune positioning before final attachment, which may be particularly useful in precision optical assembly and automated photonic packaging processes.

In some embodiments, the alignment features may also include elastic or compliant components, such as spring-loaded guide pins, flexible polymer interfaces, or microstructured compliance zones, which may allow for controlled deformation to accommodate thermal expansion, mechanical stress, or minor manufacturing tolerances. This approach may be beneficial in applications where sub-micron alignment accuracy is required while maintaining structural integrity over repeated assembly cycles.

In further reference to FIG. 1, in an embodiment, second sub-assembly 132 may further include an opto-fluidic second sub-assembly including a plurality of microfluidic components. An “opto-fluidic second sub-assembly,” as used throughout this disclosure, is a modular component that integrates optical and fluidic elements within a single platform, designed to manipulate and analyze fluids using light-based technologies. As used herein, a plurality of “microfluidic components” are the building blocks of a microfluidic system, designed to manipulate, transport, and analyze small volumes of fluids within microscale channels and structures. In an embodiment, plurality of microfluidic components may include microchannels, micropumps, microvalves, mixers, reservoirs, detectors and sensors, filters, heaters and temperature controllers, electrodes, droplet generators, and/or the like. In an embodiment, the fluidic network, including channels, valves, and other driving elements may be realized on the backside of a wafer making the features to be part of the bottom fixture.

Still referring to FIG. 1, in an embodiment, first sub-assembly 104 may further include one or more microfluidic drivers configured to interrogate with the opto-fluidic second sub-assembly including one or more pumps, and one or more mechanical gripping elements. For purposes of this disclosure, one or more “microfluidic drivers” are components that manage actuation mechanisms that manipulate fluid flow within microchannels. In an embodiment, a microfluidic driver may include manual means of effecting actuation mechanisms. Alternatively, and/or additionally, microfluidic drivers may include automatic actuation mechanisms. In an embodiment, one or more pumps may include syringes, limit sensors, steppers, and/or other motors. As used herein, one or more “mechanical gripping elements” refers to components designed to physically grasp, manipulate, or position microfluidic devices or their internal components. The inclusion of one or more mechanical gripping elements may increase alignment and integration within microfluidic setups, ensuing accurate fluid control and system functionality.

In continued reference to FIG. 1, in an embodiment, microfluidic embodiments of apparatus 100 and associated microfluidic components may be consistent with any microfluidic device described in Attorney Docket No. 1214-008USC1, U.S. patent application Ser. No. 18/909,532, filed on Oct. 8, 2024, entitled “APPARATUS AND METHODS FOR PERFORMING MICROFLUIDIC-BASED BIOCHEMICAL ASSAYS,” the entirety of which is incorporated herein by reference.

With further reference to FIG. 1, in an embodiment, first high tolerance grating coupler 124 and second high tolerance grating coupler 140 may include a 300 μm aperture and a 9 mm working distance. As used herein, the “aperture” of a grating coupler, refers to the effective area over which light is diffracted and coupled into or out of the waveguide. In an embodiment, the larger the aperture, the higher the coupling efficiency. For purposes of this disclosure, the “working distance” is the separation between the free-space optical source 112 and the grating coupler at which optimal coupling occurs. In an embodiment, aperture may define the light collection area and influence efficiency and mode matching to waveguides or optical fibers. Whereas, the working distance may affect beam divergence, mode overlap, and phase-matching conditions, all of which may impact coupling performance. In an embodiment, both parameters must be carefully optimized to minimize optical losses, enhance coupling efficiency, and ensure stable operation in integrated photonic systems.

Still referring to FIG. 1, in an embodiment, first high tolerance grating coupler 124 and second high tolerance grating coupler 140 may include at least a reflector, wherein the at least a reflector is configured to recycle lost light back into the high tolerance grating coupler. First high tolerance grating coupler 124 may include at least a first reflector and second high tolerance grating coupler 140 may include at least a second reflector. For purposes of this disclosure, at least a “reflector” is an optical component integrated into or positioned near the grating coupler to redirect and recycle lost light back into the waveguide. Multi-layer dielectric in the same material as the waveguide may be used, for instance and without limitation, for simplicity of manufacturing. However, as mentioned in the rest of the of the paragraph, other approaches like bottom metallic reflectors or a combination of materials (Si, SiN, Poly-Si, or polymers like SU-8, BCB etc.) multi-material layered reflectors can be used as desired. In an embodiment, at least a reflector may enhance coupling efficiency and reduce optical losses. This may be so, at least in part, due to the reflector's ability to recycle lost light, and/or minimizing back reflection into the optical source 112. In an embodiment, at least a first reflector and at least a second reflector may include metallic reflectors, distributed Bragg reflectors, dielectric reflectors, and/or curved or angled reflectors. For example, at least a first reflector and at least a second reflector may include a multi-layer Distributed Bragg Reflector. In an embodiment, the reflector may be placed to match the phase of the reflected wave with the incoming optical field.

In certain embodiments, the reflector may be designed as a multi-layer optical structure to enhance reflection efficiency across the operational wavelength range. A multi-layer Distributed Bragg Reflector (DBR), for example, may include alternating layers of materials with differing refractive indices, where each layer thickness is optimized to create constructive interference for reflected waves. By carefully selecting the number of layers, thickness, and refractive index contrast, such DBRs may be tailored to achieve near-total reflectivity for a specific wavelength band. Additionally, in some configurations, a backing reflector may be positioned beneath the alternating layer pairs to increase light recycling efficiency. This backing reflector may be implemented as a high-reflectivity metal layer, such as gold or aluminum, or as a high-index contrast dielectric mirror, providing an additional mechanism for redirecting light back into the coupler. The choice of reflective materials may depend on the operational wavelength range of the photonic system. Suitable materials may include gold, silver, aluminum, silicon/silicon dioxide DBR layers, titanium dioxide and silicon nitride, and/or the like. In some embodiments, the reflector's material and structural configuration may be optimized for a specific wavelength range, beam divergence angle, or polarization state to maximize coupling efficiency. The placement of the reflector may also be optimized to ensure that the reflected optical wave maintains phase coherence with the incoming optical signal, further improving light recovery and minimizing losses.

In continued reference to FIG. 1, in an embodiment, first sub-assembly 104 may further include a first edge coupler, wherein the first edge coupler is configured to convey light from at least a first photonic chip 108 to first high tolerance grating coupler 124. Further, second sub-assembly 132 may include a second edge coupler, wherein the second edge coupler is configured to convey light from at least a second photonic chip 136 to second high tolerance grating coupler 140. For purposes of this disclosure, an “edge coupler” is an optical component used to transfer light between a free-space optical beam and an integrated photonic waveguide by aligning the light's propagation direction with the waveguide's edge, rather than coupling it vertically. In an embodiment, first edge coupler and second edge coupler may include direct butt coupling, tapered edge couplers, lens-assisted edge couplers, and/or the like.

Still referring to FIG. 1, in an embodiment, first sub-assembly 104 and second sub-assembly 132 may include top and bottom mechanical fixtures. Wherein first sub-assembly 104 may include a first top mechanical fixture and a first bottom mechanical fixture, and second sub-assembly 132 may include a second top mechanical fixture and a second bottom mechanical fixture. For purposes of this disclosure, “mechanical fixture” refers to a precisely engineered component or assembly designed to align and secure optical elements. In an embodiment, first top mechanical fixture and first bottom mechanical fixture may be configured to fit together with second top mechanical fixture and second bottom mechanical fixture. This “fit” may include a slip fit and/or an engineering fit. As used herein, “slip fit” is a type of mechanical fit that allows two mating components to easily slide or slip into each other with minimal resistance, while still maintaining alignment and stability. This may, for example, include loose slip fits or precision slip fits. Herein, precision slip fits may be utilized to maintain low optical loss. An “engineering fit,” as used throughout this disclosure, refers to the degree of tightness or looseness between two mating components in a mechanical assembly. The fit may determine whether the parts can slide together easily, require force for assembly, or are permanently fixed. Engineering fits may be classified based on the tolerance and clearance between the components. For example, engineering fits may include clearance fits, interference fits, and/or transition fits. In some cases, clearance fits may include loose fit. In an embodiment, interference fits may include press fit and/or force fit. Further, transition fit may include slip and/or press fit. In an embodiment, different fits may be used for different components of apparatus 100. For example, and without limitation, slip fits or clearance fit may be used in waveguide assembly, press fits or interference fit may be used in permanently fixed optical mounts, and precision transition fits may be used in aligning grating couplers to a photonic chip.

With further reference to FIG. 1, in an embodiment, first top mechanical fixture, first bottom mechanical fixture, second top mechanical fixture, and second bottom mechanical fixture may be machined using one or more materials including thermoplastics, metals, and/or ceramics. In an embodiment, thermoplastics may be suitable for lightweight, cost-effective, and corrosion-resistant mechanical fixtures. For example, thermoplastics may be used in biomedical, lab-on-chip, and/or microfluidic systems. In an embodiment, thermoplastics may include polyetheretherketone (PEEK), Polymethyl methacrylate (PMMA), polycarbonate (PC), and/or acrylonitrile butadiene styrene (ABS). In an embodiment, metals may offer high structural stability, thermal conductivity, and/or durability, which may be useful in applications such as industrial and/or aerospace photonics applications where robust coupling mechanisms are required. In an embodiment, ceramics may provide high-temperature resistance, electrical insulation, and/or excellent dimensional stability. This may make ceramics suitable for use in harsh environments, semiconductor photonics, and/or optoelectronic packaging applications, where resistance to thermal expansion and chemical exposure is critical. In an embodiment, ceramic material may include alumina (Al₂O₃), zirconia (ZrO₂), and/or silicon carbide (SIC).

In continued reference to FIG. 1, in an embodiment, apparatus 100 may include a thermal element. Wherein the thermal element is configured to maintain an optimal operating temperature of the one or more photonic chips. In an embodiment, the thermal element may include a thermal sensing element and a heating element which may work in conjunction to monitor and regulate the temperature of the photonic system. Temperature stability may be beneficial for ensuring consistent optical performance, minimizing drift, and optimizing signal integrity in photonic circuits.

In an embodiment, the thermal sensing element may be realized through various techniques. For example, the thermal sensing element may include resistive temperature sensors, which may be fabricated using metallic deposition and patterning, such as platinum (Pt) thin films, or through polysilicon resistors. In another embodiment, the thermal sensing element may include ion-implanted or diffused semiconductor temperature sensors, where doping specific regions of the chip with materials such as boron or phosphorus may create a temperature-sensitive resistive structure. Alternatively, an external thermistor may be soldered onto designated contact pads on the sensor chip. In some embodiments, infrared or optical temperature sensors may be used for non-contact temperature monitoring, wherein optical wavelength shifts in Bragg gratings or resonators may be analyzed to determine temperature changes. Additionally, a thermocouple, which may generate an electrical signal based on temperature differentials between two dissimilar metals, may be incorporated to provide robust temperature measurement, particularly in environments where conventional sensors may be impractical.

In an embodiment, the heating element may be designed to provide localized or distributed heating to maintain the photonic chip at an optimal temperature. The heating element may be implemented using metallic thin-film resistors, which may be fabricated through plating and patterning of metals such as titanium nitride (TiN), platinum (Pt), or nichrome (NiCr) on the backside of the wafer. In another embodiment, the heating element may include a bonded external resistive heating element, such as a polyimide-based resistive heater or ceramic heater, which may be affixed to the back of the sensor chip to provide additional thermal stability. Alternatively, the heating element may include silicon micro-heaters, which may be integrated into the photonic chip itself. In some embodiments, Peltier elements, such as thermoelectric coolers/heaters, may be used for both heating and cooling of the system. In certain implementations, Joule heating via integrated waveguides may be employed, wherein optical absorption of a control laser beam within a waveguide may be used to provide localized heating.

With further reference to FIG. 1, in an embodiment, system 100 may include a computing device. Computing device includes at least a processor communicatively connected to a memory. As used in this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Further referring to FIG. 1, computing device may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Computing device may include a single computing device operating independently, or may include two or more computing device operating in concert, in parallel, sequentially or the like; two or more computing devices may be included together in a single computing device or in two or more computing devices. Computing device may interface or communicate with one or more additional devices as described below in further detail via a network interface device. Network interface device may be utilized for connecting computing device to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device may include but is not limited to, for example, a computing device or cluster of computing devices in a first location and a second computing device or cluster of computing devices in a second location. Computing device may include one or more computing devices dedicated to data storage, security, distribution of traffic for load balancing, and the like. Computing device may distribute one or more computing tasks as described below across a plurality of computing devices of computing device, which may operate in parallel, in series, redundantly, or in any other manner used for distribution of tasks or memory between computing devices. Computing device may be implemented, as a non-limiting example, using a “shared nothing” architecture.

With continued reference to FIG. 1, computing device may be designed and/or configured to perform any method, method step, or sequence of method steps in any embodiment described in this disclosure, in any order and with any degree of repetition. For instance, computing device may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

In continued reference to FIG. 1, in an embodiment, the thermal control circuit may regulate temperature by using an analog circuit, a digital circuit, and/or a combination thereof. In one embodiment, an analog feedback loop may be used to regulate power to the heating element based on temperature changes. For example, a Wheatstone bridge circuit may be used with a resistive temperature sensor to generate an error signal based on deviations from a reference temperature. In another embodiment, a transistor-based switching circuit may be used to control the current flow to the heating element, adjusting heating in real time. In some embodiments, an operational amplifier (op-amp) circuit may provide precise proportional-integral-derivative (PID) control, allowing for fine-tuned temperature stability without overshooting.

Alternatively, in some embodiments, temperature control may be managed by a digital control system, which may be implemented in first sub-assembly 104 or an external controller. The digital control system may include an application-specific integrated circuit (ASIC) that provides built-in feedback loops to ensure rapid response to temperature fluctuations. In another embodiment, a microcontroller (e.g., ARM Cortex-M, PIC, or AVR) may process temperature sensor data and dynamically adjust heater power based on pre-programmed algorithms. In some embodiments, a field-programmable gate array (FPGA)-based controller may be used to enable real-time temperature regulation while integrating additional system monitoring functions. Additionally, pulse-width modulation (PWM) control may be used to regulate the power delivered to the heating element, allowing for fine control of heating intensity. In certain embodiments, machine learning-based control algorithms may be incorporated to analyze thermal response data over time and adjust heating parameters dynamically to optimize thermal efficiency.

In an embodiment, the thermal sensing and heating elements may be integrated with first sub-assembly 104 using various techniques. In some embodiments, flexible printed circuit boards (FPCBs) may be used to route power and control signals between the thermal elements and control circuits, ensuring compact integration. In another embodiment, through-silicon vias (TSVs) may be used to establish vertical electrical interconnects between different layers of the photonic chip, reducing the need for external wiring. Additionally, electrical contacts for the heating and sensing elements may be made using wire bonding or flip-chip bonding, optimizing thermal and electrical performance. By incorporating a precise thermal sensing element, a controlled heating element, and an integrated thermal control circuit, the disclosed system may provide stable operating conditions for the photonic system, improving wavelength stability, refractive index consistency, and system reliability. In some embodiments, the thermal control system may minimize temperature-induced phase noise or optical signal degradation, ensuring consistent photonic performance. Additionally, energy-efficient temperature regulation techniques may be used to optimize power consumption while maintaining thermal stability.

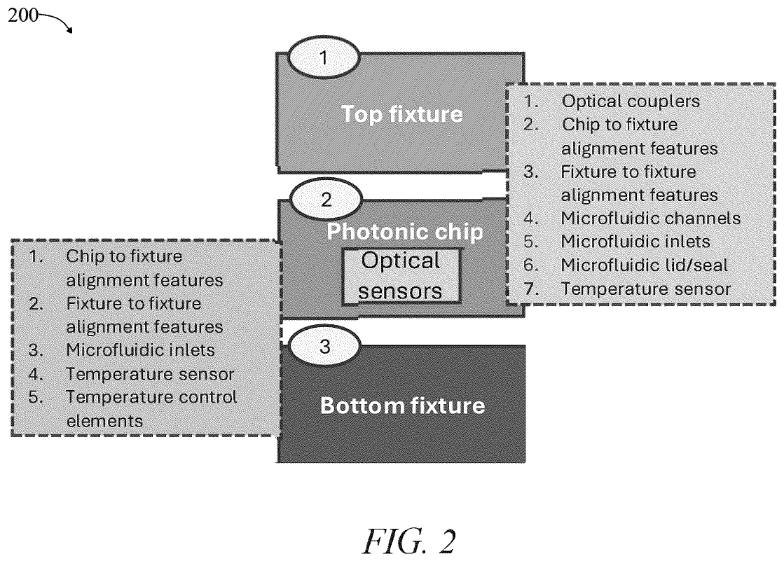

Now referring to FIG. 2, illustrated is an exemplary architecture of a second sub-assembly that may consist of (1) top and (3) bottom mechanical fixtures (2) one or more disposable photonic chips consisting of sensing regions that may be functionalized for biomedical or chemical sensing requirements. The external optical interfacing is accomplished through fabrication, and alignment tolerant multi-layer dielectric Distributed Bragg Reflector based grating couplers whose alignment tolerance requirements are alleviated through on-chip, and on-fixture, and fixture-fixture alignment structures. The thermal control interface may include a temperature sensing element such as a thermistor and a temperature control element with their respective external electrical interfaces. The physical layout of these elements and their interfacing may be distributed to be on-the chip and off-the chip/on-fixture. The sub assembly may also feature microfluidic components such as sample input mechanisms, fluidic channels, microneedles, actuators, valves, inlets, and lids.

Now referring to FIG. 3, shown is the frontal and side cross-sections of an exemplary embodiment of the photonic chip(s) that are a part of the second sub-assembly. The key elements include grating couplers resilient to variations in fabrication and alignment, thermal control elements, and trench structures (oxide open, deep trench, and thru silicon). The side cross-section shows the mechanical, fluidic, and thermal interfacing of different key elements with the top and bottom fixtures of a chip and the external opto-mechanical interface that plugs into the first sub-assembly. Second sub-assembly 300 may include, and/or be attached to, one or more alignment structures 304, which may be adjoined to sub-assembly via one or more alignment features, for instance and without limitation as described in further detail below.

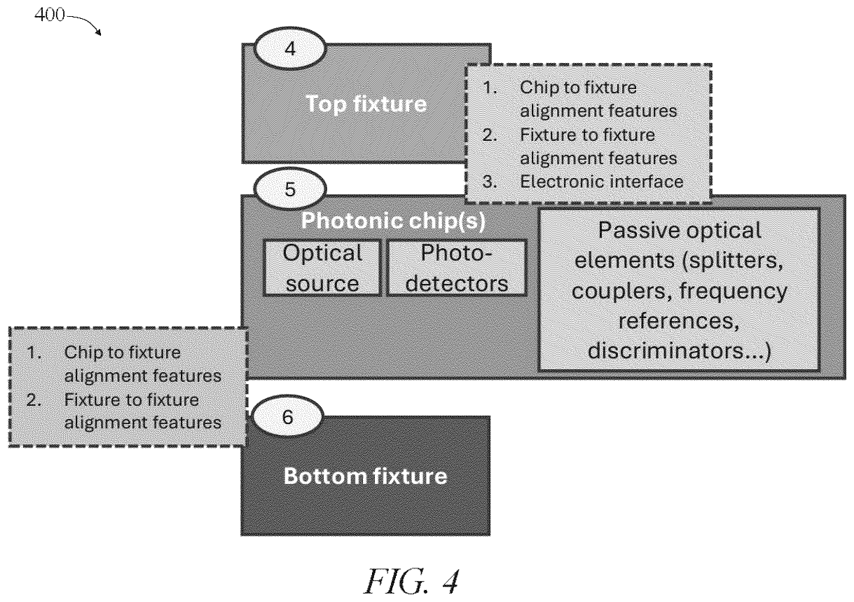

Now referring to FIG. 4, illustrated is an exemplary embodiment of the first sub-assembly architecture consisting of (4) top and (6) bottom fixtures that seat (6) one or more passive/active PICs and allow electrical interfacing for control, acquisition electronics for optoelectronic, thermal, and fluidic control and monitoring. The photonic chipset may consist of an electrically/thermally tunable laser source and an on-chip/off-the shelf photo-detector array chips that are optically interfaced via pick-place+bonding or via hybrid/heterogenous integration or micro-transfer printing on a silicon photonic chip that may consist of passive optical elements such as optical couplers, frequency discriminator in addition to the grating couplers that allow interfacing with the photonic chips in the second sub-assembly.

Now referring to FIG. 5, illustrated is a detailed list of key elements that may be a part of the reader subassembly. In addition to the elements present in the second sub-assembly, the first sub-assembly may house active photonic elements and one or more thermal control elements. The figure shows a couple of non-limiting variants to realize temperature sensing elements that include interfacing with an external thermistor or an on-chip photonic polysilicon-based resistor that can be used to accurately sense temperature. The optical source is shown to be dropped in the trench created via deep etching into the substrate of the passive PIC. First sub-assembly 500 may include, and/or be attached to, one or more alignment structures 304, which may be adjoined to sub-assembly via one or more alignment features, for instance and without limitation as described in further detail below.

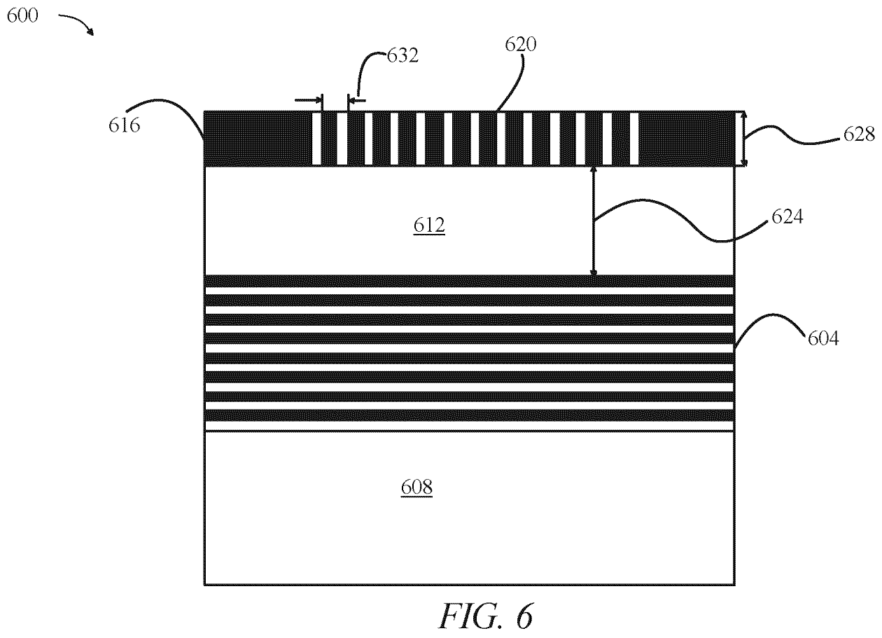

Now referring to FIG. 6 shown is a schematic illustration of a grating coupler element 600 having a waveguide and a bottom reflector is provided. The multilayer reflector may include a stack 604 of two or more alternating layers of materials having different reflective indices, such as without limitation alternating layers of SiO₂ and SiNₓ. Stack 604 may include an odd number of layers. Stack 604 may include an even number of layers Stack 604 may be deposited and/or formed on top of a substrate 608, which may be formed from any suitable material such as without limitation SiO₂, SiNₓ or the like. Coupler 60 may include a buffer layer 612 deposited and/or formed on top of the stack 604; buffer layer 612 may be formed, as a non-limiting example, from SiO₂, SiNₓ, or the like. A waveguide layer 616 including a grating 620 may be deposited on top of the stack and/or buffer layer 612. Waveguide layer may be formed from any suitable material such as without limitation SiO₂, SiNₓ or the like. Thickness 624 of buffer 612, and/or distance from waveguide 616 to stack 604 may be any suitable width, such as without limitation approximately 2.8 μm. Thickness 628 of waveguide 616 may be any suitable width such as without limitation 325 nm. Grating 620 may have a period 632, denoted here as A which may be set according to a wavelength-related thickness λ₀, where λ₀ may be set to some proportion and/or fraction of a wavelength of a light frequency to be passed through the coupler, such as a wavelength, half-wavelength, quarter-wavelength, or the like. Alternatively or additionally, the relationship of λ₀ to wavelength may vary with variations in wavelength of a varied set of light frequencies, such as a set of frequencies through which a variable laser may be swept. Relation of grating period to λ₀ may follow any suitable relation employed for gratings, such as Bragg gratings; for instance and without limitation, relation may be formed according to the equation:

$$Λ = \frac{{λ}_{0}}{{n}_{eff} - {n}_{c} sin θ}$$

where n_{c} is a refractive index of a cladding material, θ is a coupling angle, and n_{eff} is the effective refractive index. In other embodiments, a grating used in a grating coupler may include a non-uniform period. For instance, and without limitation, spacing of the grating maybe based on a linear apodization of the grating; in other words, a filling factor may vary linearly along a length of the grating.

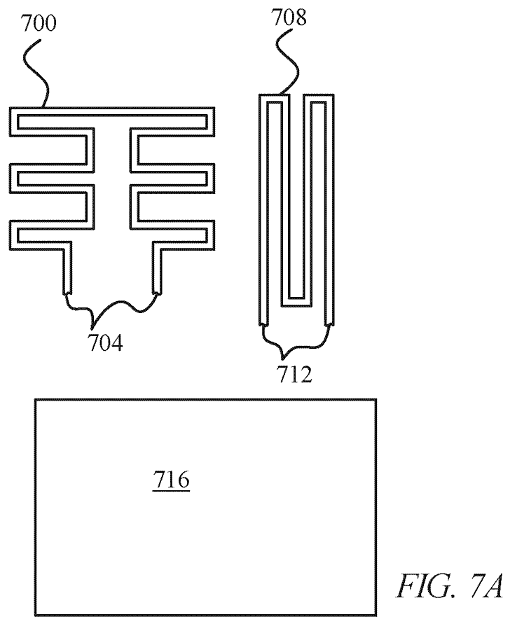

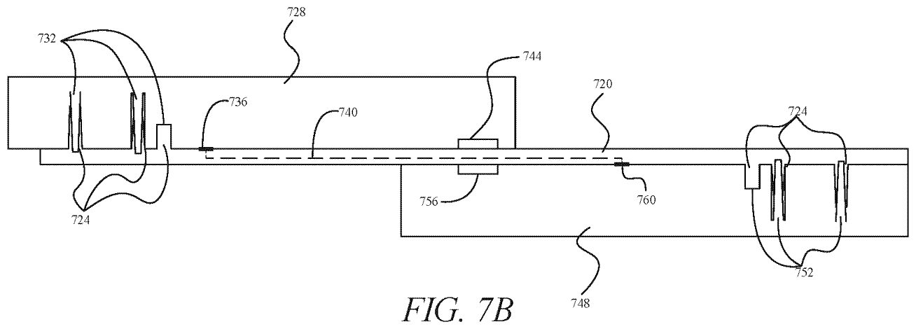

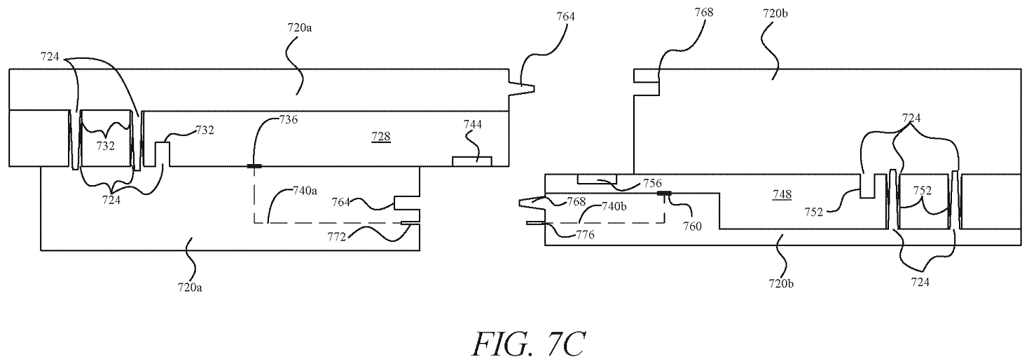

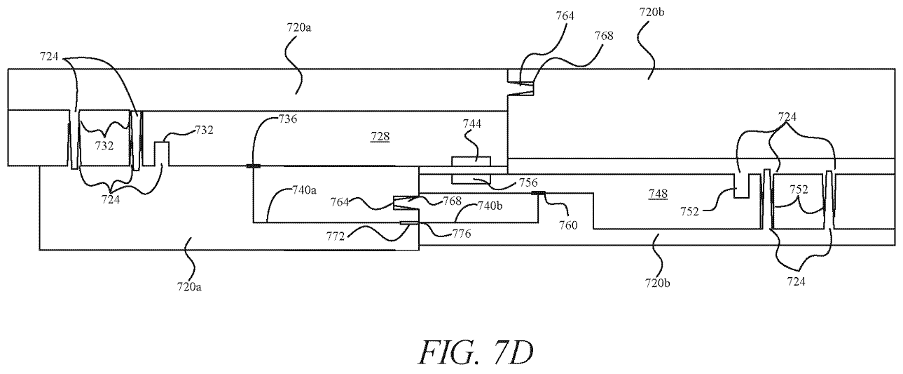

Now referring to FIG. 7A exemplary microheater 700 is illustrated. Microheater 700 may include a resistive heating element 704, such as a wire or other conductive material that converts electrical energy to heat. One or more electrical connections 708a-b may connect to a power source (not shown) via, for instance, electrical pathways or circuits as described in further detail below. A control circuit such as a microprocessor and/or comparator may switch power to microheater 700 on or off based on, for instance, comparison of a sensed temperature to a threshold, where a turn-on or lower threshold may be less than a turn-off or higher threshold to prevent cycling. Microheater 700 may be deposited or formed on a plate, a chip formed in a chip fabrication process, or the like. Microheater may be disposed beneath an active or testing surface of a sensor subassembly to, e.g., maintain one or more chemical or biological agents and/or analytes at an optimal detection temperature by heating such agents and/or analytes until a threshold representing the optimal detection temperature or approximately the optimal detection temperature is reached.

Still referring to FIG. 7A, subassemblies or assembly may include a temperature detector 708, such as without limitation a thermistor, a heat-conductive element attached to a thermistor, or the like. Temperature detector 708 may be disposed on the same plate and/or chip as microheater 700 and/or in a location to be heated such as underneath, attached to, and/or in communication with an active region of a sensor subassembly. Electrical connectors 712 may connect, in a non-limiting example, to a control circuit 716 that controls power to microheater 700; for instance and without limitation, electrical connectors may connect to analog input pins and/or to digital input pins via an analog/digital converter, a comparator, or the like. Control circuit 716 may include a comparator or other operational amplifier or operational amplifier circuit, a combinatorial or sequential logic circuit, an application-specific integrated circuit (ASIC), an FPGA, and/or a microprocessor, which may be incorporated in and/or communicatively connected to assembly, subassemblies, or other elements described in this disclosure.

Referring now to FIG. 7B, an exemplary embodiment of an assembly combining elements as described above is illustrated. At least an alignment structure 720 may connect together elements of assembly, and may correspond to parts that connect to reader and/or sensor sub-assemblies via alignment features such as without limitation projections inserted into vias or through-holes as described above; at least an alignment structure 720 may be designed and/or manufactured in any manner described above in reference to FIGS. 1-7A. For instance, and without limitation, one or more components of at least an alignment structure 720 may be produced using precision molding processes such as without limitation precision injection molding. Alternatively or additionally, one or more components of at least an alignment structure may be performed using an additive manufacturing device, which may include without limitation any device designed or configured to produce a component, product, or the like using an additive manufacturing process, in which material is deposited on the workpiece to be turned into the finished result. In some embodiments, an additive manufacturing process is a process in which material is added incrementally to a body of material in a series of two or more successive steps. The material may be added in the form of a stack of incremental layers; each layer may represent a cross-section of the object to be formed upon completion of the additive manufacturing process. Each cross-section may, as a non-limiting example be modeled on a computing device as a cross-section of graphical representation of the object to be formed; for instance, a computer aided design (CAD) tool may be used to receive or generate a three-dimensional model of the object to be formed, and a computerized process may derive from that model a series of cross-sectional layers that, when deposited during the additive manufacturing process, together will form the object. The steps performed by an additive manufacturing system to deposit each layer may be guided by a computer aided manufacturing (CAM) tool. In other embodiments, a series of layers are deposited in a substantially radial form, for instance by adding a succession of coatings to the workpiece. Similarly, the material may be added in volumetric increments other than layers, such as by depositing physical voxels in rectilinear or other forms. Additive manufacturing, as used in this disclosure, may specifically include manufacturing done at the atomic and nano level. Additive manufacturing also includes bodies of material that are a hybrid of other types of manufacturing processes, e.g. forging and additive manufacturing as described above. As an example, a forged body of material may have welded material deposited upon it which then comprises an additive manufactured body of material.

Still referring to FIG. 7B, deposition of material in additive manufacturing processes may be accomplished by any suitable means. Deposition may be accomplished using stereolithography, in which successive layers of polymer material are deposited and then caused to bind with previous layers using a curing process such as curing using ultraviolet light. Additive manufacturing processes may include “three-dimensional printing” processes that deposit successive layers of power and binder; the powder may include polymer or ceramic powder, and the binder may cause the powder to adhere, fuse, or otherwise join into a layer of material making up the body of material or product. Additive manufacturing may include metal three-dimensional printing techniques such as laser sintering including direct metal laser sintering (DMLS) or laser powder-bed fusion. Likewise, additive manufacturing may be accomplished by immersion in a solution that deposits layers of material on the body of material, by depositing and sintering materials having melting points such as metals, such as selective laser sintering, by applying fluid or paste-like materials in strips or sheets and then curing that material either by cooling, ultraviolet curing, and the like, any combination of the above methods, or any additional methods that involve depositing successive layers or other increments of material. Methods of additive manufacturing may include without limitation vat polymerization, material jetting, binder jetting, material extrusion, fuse deposition modeling, powder bed fusion, sheet lamination, and directed energy deposition. Methods of additive manufacturing may include adding material in increments of individual atoms, molecules, or other particles. An additive manufacturing process may use a single method of additive manufacturing, or combine two or more methods.

Continuing to refer to FIG. 7B, additive manufacturing may include deposition of initial layers on a substrate. Substrate may include, without limitation, a support surface of an additive manufacturing device, or a removable item placed thereon. Substrate may include a base plate, which may be constructed of any suitable material; in some embodiments, where metal additive manufacturing is used, base plate may be constructed of metal, such as titanium. Base plate may be removable. One or more support features may also be used to support additively manufactured body of material during additive manufacture; for instance and without limitation, where a downward-facing surface of additively manufactured body of material is constructed having less than a threshold angle of steepness, support structures may be necessary to support the downward-facing surface; threshold angle may be, for instance 45 degrees. Support structures may be additively constructed, and may be supported on support surface and/or on upward-facing surfaces of additively manufactured body of material. Support structures may have any suitable form, including struts, buttresses, mesh, honeycomb or the like; persons skilled in the art, upon reviewing the entirety of this disclosure, will be aware of various forms that support structures may take consistently with the described methods and systems.

Still referring to FIG. 7B, an additive manufacturing device may include an applicator or other additive device. For instance, an additive manufacturing device may include a printer head for a 3D printer. An additive manufacturing device may include an extruding device for extruding fluid or paste material, a sprayer or other applicator for bonding material, an applicator for powering, a sintering device such as a laser, or other such material.

Continuing to refer to FIG. 7B, an additive manufacturing device may include one or more robotic elements, including without limitation robot arms for moving, rotating, or otherwise positioning a workpiece, or for positioning a manufacturing tool, printer heads, or the like to work on workpiece. An additive manufacturing device may include one or more workpiece transport elements for moving a workpiece or finished part or component from one manufacturing stage to another; workpiece transport elements may include conveyors such as screw conveyors or conveyor belts, hoppers, rollers, or other items for moving an object from one place to another.

Further referring to FIG. 7B, at least an alignment structure and/or any components thereof may be manufactured using one or more subtractive manufacturing processes. One or more steps may include a subtractive manufacturing process, which produces the product by removing material from a workpiece; the removal of material may be accomplished using abrasives, cutting tools or endmills, laser cutting or ablation, removal using heat, or any other method that removes material from the workpiece. Each subtractive manufacturing process used may be any suitable process, such as, but not limited to, rotary-tool milling, electronic discharge machining, ablation, etching, erosion, cutting, sawing, sanding, polishing, grinding, and cleaving, among others.

Still referring to FIG. 7B, if rotary-tool milling is utilized, this milling may be accomplished using any suitable type of milling equipment, such as milling equipment having either a vertically or horizontally oriented spindle shaft. Examples of milling equipment include bed mills, turret mills, C-frame mills, floor mills, gantry mills, knee mills, and ram-type mills, among others. In some embodiments, the milling equipment used for removing material may be of the computerized numerical control (CNC) type that is automated and operates by precisely programmed commands that control movement of one or more parts of the equipment to effect the material removal. CNC machines, their operation, programming, and relation to CAM tools and CAD tools are well known and need not be described in detail herein for those skilled in the art to understand the scope of the present invention and how to practice it in any of its widely varying forms.

With continued reference to FIG. 7B, subtractive manufacturing may be performed using spark-erosive devices; for instance, subtractive manufacturing may include removal of material using electronic discharge machining (EDM). EDM may include wire EDM, plunge EDM, immersive EDM, ram EDM, or any other EDM manufacturing technique. Subtractive manufacturing may be performed using laser-cutting processes. Subtractive manufacturing may be performed using water-jet or other fluid-jet cutting techniques.

Still referring to FIG. 7B, at least an alignment structure 720 may be formed as a monolithic whole and/or as two or more elements that connect to each other and/or to alignment features of other components of assembly. Fundamentally, any process for removal of material may be employed for subtractive manufacturing. Any process suitable for manufacture of at least an alignment structure 720 may alternatively or additionally be used to form or manufacture any other component described in this disclosure.

With further reference to FIG. 7B, at least an alignment structure 720 may include one or more alignment features 724; these may be implemented in any manner suitable for implementation of alignment features as described in this disclosure. In an embodiment, alignment features 724 may be positioned to place reader and/or sensor units in combination in assembly such that grating couples are aligned within vertical and horizontal tolerances for successful signal transmission.

Continuing to refer to FIG. 7B, at least an alignment structure 720 may be connected to a reader 728. Reader 728 may include any reader sub-assembly described in this disclosure, and/or may by a first or second sub-assembly as described in this disclosure. Connection of reader to at least an alignment structure 720 may be performed, without limitation, using reader alignment features 732, which may connect with alignment features 724 in any manner described in this disclosure. Electrical pad/electrode connections may connect electronics of reader 728 to an electronic path and/or circuit within at least an alignment structure 720. Similarly, microfluidics paths may pass through at least an alignment structure 720 from or two other sub assemblies. Reader subassembly may include a reader grating 744, which may make up one half of a grating coupling as described in this disclosure.

Still referring to FIG. 7B, a sensor subassembly 748 may be connected to the at least an alignment structure 720 using sensor subassembly alignment features 752; these may be implemented, without limitation, in any manner described in this disclosure. In some embodiments, connection of reader subassembly 728 and sensor subassembly 748 to alignment structure 720 may align reader grating 744 with a sensor grating 756 to form a grating coupling with alignment within working distances and horizontal displacement tolerances as described above for signal transmission. Electrical pads and/or connectors may connect electrical elements of sensor subassembly, including without limitation heating elements and/or temperature sensors as described above, to electrical pathway and/or circuit 740, and thence to electrical elements and/or connectors of reader subassembly 728. Microfluidics, electronic, and other connectors may connect to exterior components via one or more openings in at least an alignment structure 720 without limitation as described above in reference to FIGS. 1-7A. At least an alignment structure 720 may be formed as a monolithic whole, for instance in a single injection molding and/or other manufacturing process, by forming two or more pieces and assembling them, and/or by forming two or more pieces, attaching them to subassemblies, and then joining the subassemblies and the portions of the at least alignment structure 720 to one another to form an assembly.

Referring now to FIG. 7C, in some embodiments at least an alignment structure 720 includes at least a first alignment structure 720a connected to reader and/or first sub-assembly 728 and at least a second alignment structure 720b connected to sensor and/or second sub-assembly 748; each of at least a first alignment structure 720a and at least a second alignment structure 720b may surround respective subassemblies in a form of a housing or similar structure, and may have two or more sections or portions that assemble or snap together when aligned with sub-assemblies using alignment features 724, 732, 752. At least a first alignment structure 720a may have a first set of alignment features 764 that connect to at least a second alignment structure 720b, which may effect such connection using one or more alignment features 768 of at least a second alignment structure 720b. Alignment features 764, 768 may be implemented in any manner suitable for alignment features as described in this disclosure. In an embodiment, connecting at least a first alignment structure 720a and at least a second alignment structure 720b may place first grating 744 and second grating 756 in alignment to form a grating coupler as described in this disclosure.

Still referring to FIG. 7C, electrical path and/or circuit 740 may include a first portion 740a associated with first sub-assembly 728 and/or at least a first alignment structure 748 and a second portion 740b associated with second sub-assembly and/or at least a second alignment structure 720b. First portion 740a may be electrically connected to a first electrical connector 764, which may include any single or multiple-pin digital and/or analog connector such as without limitation connectors suitable for use with computing devices, including any form of universal serial bus (USB), pulse-width modulation (PWM), universal asynchronous receiver/transmitter (UART) connectors, or the like. Second portion 740b may be electrically connected to a second connector 776, which may be or include any connector complimentary to and/or interoperable with first connector 772. In some embodiments, connecting at least a first alignment structure 720a to at least a second alignment structure 720b using alignment features 764,768 will cause first electrical connector 772 to connect with second electrical connector 776, placing first portion 740a in electrical communication with second portion 740b, permitting electrical power and/or signals to pass between first subassembly 728 and second subassembly 748.

Referring now to FIG. 7D, an exemplary embodiment is illustrated, in which a first alignment structure 720a is attached to a second alignment structure 720b, as described above in reference to FIG. 7C, using alignment features 764, 768. Further illustrated for exemplary purposes are first grating 744 and second grating 756 placed in alignment to function as a grating coupler, and first connector 772 is illustrated as electrically connected to second connector 776.

It is to be noted that in FIGS. 7B-7D some features of subassemblies as described in this disclosure are omitted for the sake of clarity; any or all such features may be included in subassemblies 728, 748 consistently with other figures and/or description in this disclosure.

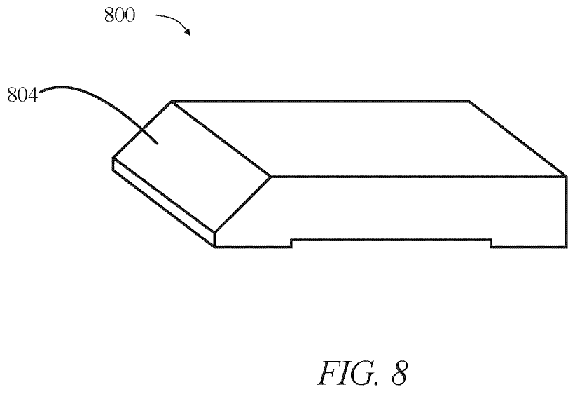

Referring now to FIG. 8, shown is an exemplary alignment feature 800, specifically illustrating a beveled edge 804. In an embodiment, the pluggable inter-chip optical coupler may incorporate various alignment features. In some cases, the beveled edge 804 may include a chamfered edge. Specifically, these alignment features may include chamfered or beveled edges along the mating surfaces. These tapered edges may serve as guiding ramps that facilitate the initial engagement between the two coupler halves. As the components are brought together, the sloped surfaces may make first contact, compensating for minor misalignments and gently steering the parts into the proper position. This self-aligning feature may minimize insertion forces and reduce the risk of damaging delicate optical interfaces, ensuring that the optical axes of the chips are accurately aligned for optimal performance.

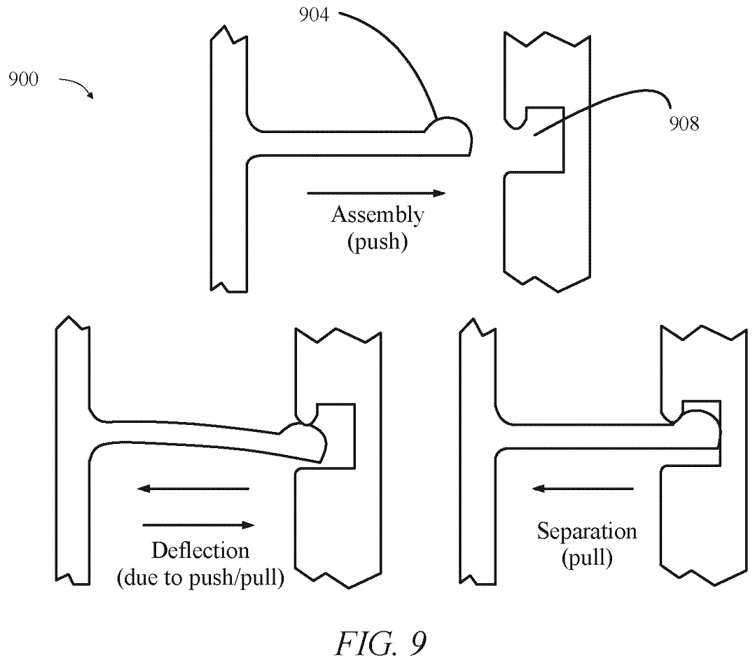

Referring now to FIG. 9, shown is an exemplary alignment feature 900, specifically illustrating a snap-fit configuration. In an embodiment, alignment feature 900 may include a snap-fit configuration. One part of the coupler may be equipped with a flexible latch or hook 904, while the mating part features a complementary notch or groove 908. In some cases, the pluggable inter-chip coupler may include a plurality of alignment features. For example, an embodiment may include both a snap-fit configuration and a beveled edge. After the beveled edges have helped achieve preliminary alignment, the snap-fit mechanism may provide a secure mechanical lock that holds the components together. This locking action may be designed to resist disassembly under conditions such as vibration or thermal cycling. The snap-fit not only reinforces the precise alignment established by the bevels but also offers a reliable, user-friendly means of assembly and maintenance, ensuring consistent optical performance over repeated connections.

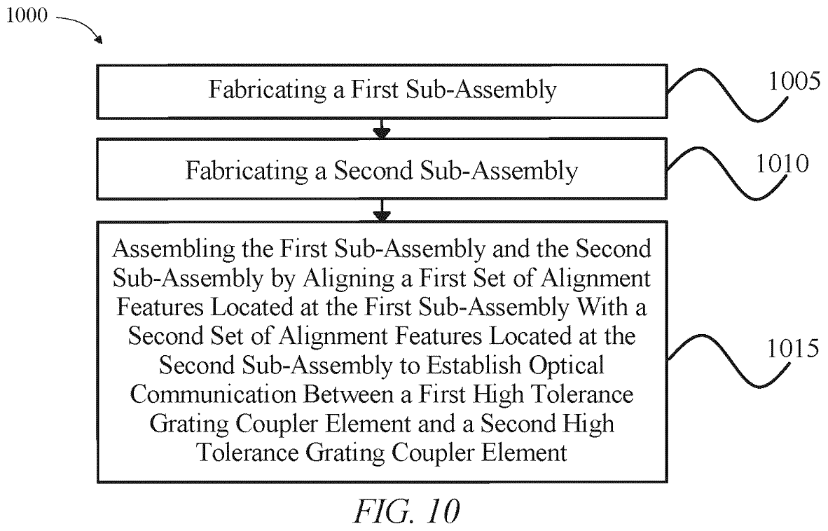

Now referring to FIG. 10, illustrates an exemplary method 1000 of manufacture for a pluggable inter-chip optical connector (PICOC). In an embodiment, method 1000 may include a step 1005 of fabricating a first sub-assembly, wherein the first sub-assembly includes forming at least a first photonic chip configured to communicate with an optical source, wherein the at least a first photonic chip includes integrating an optical source and forming one or more passive optical elements, forming a first high tolerance grating coupler element configured to optically interface with at least a second photonic chip, and forming a first set of one or more alignment features. This may be implemented, without limitation, as referenced in FIGS. 1-9.

In continued reference to FIG. 10, method 1000 may include a step 1010 of fabricating a second sub-assembly, wherein the second sub-assembly includes forming at least a second photonic chip, wherein the at least a second photonic chip includes a sensing region, forming a second high tolerance grating coupler element configured to optically interface with the at least a first photonic chip, and forming a second set of one or more alignment features configured to engage with the first set of alignment features to facilitate optical coupling. In an embodiment, forming one or alignment features may include forming one or more alignment trenches. This may be implemented, without limitation, as referenced in FIGS. 1-9.

With further reference to FIG. 10, method 1000 may include a step 1015 of assembling the first sub-assembly and the second sub-assembly by aligning the first set of alignment features with the second set of alignment features to establish optical communication between the first high tolerance grating coupler element and the second high tolerance grating coupler element. In an embodiment, step 1015 may include joining a first top mechanical fixture and a first bottom mechanical fixture with a second top mechanical fixture and a second bottom mechanical fixture using a press-fit connection. This may be implemented, without limitation, as referenced in FIGS. 1-9.

In continued reference to FIG. 10, in an embodiment, method 1000 may further include forming a first top mechanical fixture and a first bottom mechanical fixture in the first sub-assembly and forming a second top mechanical fixture and a second bottom mechanical fixture in the second sub-assembly. This may be implemented, without limitation, as referenced in FIGS. 1-9.

With further reference to FIG. 10, in an embodiment, method 1000, specifically steps in which a photonic chip is formed, may further include providing a substrate, wherein the substrate includes a material suitable for photonic integration. For purposes of this disclosure, the “substrate” is the foundational material upon which photonic and electronic components are built. The choice of substrate material may be important due to its impact on optical signal transmission, mechanical stability, thermal management, and/or overall device performance. In an embodiment, the substrate may include one or more of the following materials: silicon-on-Insulator (SOI), Indium Phsophide (InP), Silicon Nitride (LiNbO₃), glass or fused silica, and/or the like. For example, the substrate may include a silicone-on-insulator wafer. These methods may be further implemented, without limitation, as referenced in FIGS. 1-9.

Continuing to reference FIG. 10, forming a photonic chip may further include a step of applying a photoresist layer on the surface of the substrate, wherein the photoresist is sensitive to a specific wavelength of light used in a lithography process. For purposes of this disclosure, “photoresist” is a light-sensitive polymer that undergoes a chemical change when exposed to a specific wavelength of light during a lithography process. In an embodiment, photoresist may include either positive or negative photoresist. When positive photoresist is exposed to light, the exposed areas become soluble in developer solution. Alternatively, when negative photoresist is exposed to light the exposed area become insoluble, while unexposed regions dissolve during development. These methods may be further implemented, without limitation, as referenced in FIGS. 1-9.

In further reference to FIG. 10, further, forming a photonic chip may further include a step of patterning the photoresist layer by exposing it to light through a photomask, wherein the photomask defined the geometric pattern for one or more optical components to be fabricated on the substrate. In an embodiment, the one or more optical components to be fabricated may include one or more of waveguides, grating couplers, and/or photodetectors. This may be further implemented, without limitation, as referenced in FIGS. 1-9.

With continued reference to FIG. 10, in an embodiment, forming a photonic chip may further include a step of developing the exposed photoresist to reveal the underlying substrate where the photoresist was exposed to light, leaving behind a pattern that corresponds to intended optical components. This may be further implemented, without limitation, as referenced in FIGS. 1-9.

In continued reference to FIG. 10, forming a photonic chip may further include a step of etching one or more exposed areas of the substrate, using an etching process to transfer the pattern from the photoresist on the substrate. In an embodiment, the etching process may include a reactive ion etching process. This may be further implemented, without limitation, as referenced in FIGS. 1-9.

Further referencing FIG. 10, forming a photonic chip may further include a step of removing remaining photoresist, leaving one or more fabricated optical components on the substrate. This may be further implemented, without limitation, as referenced in FIGS. 1-9.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

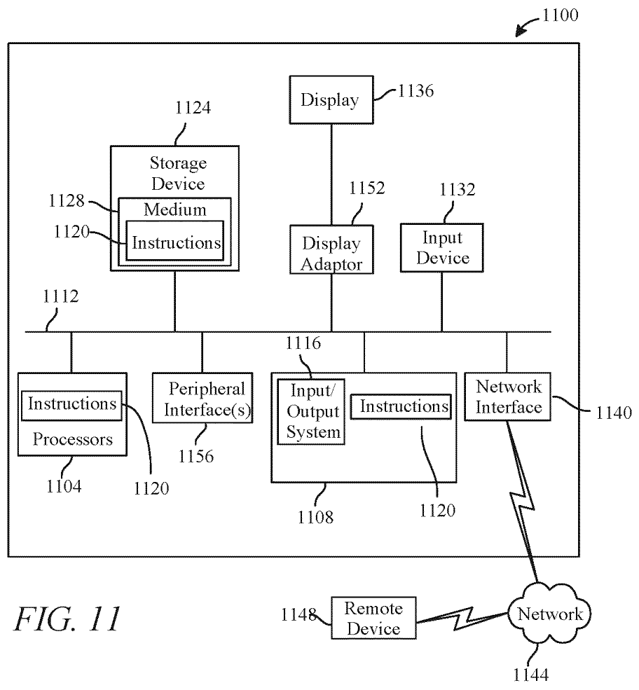

FIG. 11 shows a diagrammatic representation of one embodiment of a computing device in the exemplary form of a computer system 1100 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1100 includes a processor 1104 and a memory 1108 that communicate with each other, and with other components, via a bus 1112. Bus 1112 may include any of several types of bus structures including, but not limited to, a memory bus, a memory controller, a peripheral bus, a local bus, and any combinations thereof, using any of a variety of bus architectures.

Processor 1104 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1104 may be organized according to Von Neumann and/or Harvard architecture as a non-limiting example. Processor 1104 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 1108 may include various components (e.g., machine-readable media) including, but not limited to, a random-access memory component, a read only component, and any combinations thereof. In one example, a basic input/output system 1116 (BIOS), including basic routines that help to transfer information between elements within computer system 1100, such as during start-up, may be stored in memory 1108. Memory 1108 may also include (e.g., stored on one or more machine-readable media) instructions (e.g., software) 1120 embodying any one or more of the aspects and/or methodologies of the present disclosure. In another example, memory 1108 may further include any number of program modules including, but not limited to, an operating system, one or more application programs, other program modules, program data, and any combinations thereof.

Computer system 1100 may also include a storage device 1124. Examples of a storage device (e.g., storage device 1124) include, but are not limited to, a hard disk drive, a magnetic disk drive, an optical disc drive in combination with an optical medium, a solid-state memory device, and any combinations thereof. Storage device 1124 may be connected to bus 1112 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1124 (or one or more components thereof) may be removably interfaced with computer system 1100 (e.g., via an external port connector (not shown)). Particularly, storage device 1124 and an associated machine-readable medium 1128 may provide nonvolatile and/or volatile storage of machine-readable instructions, data structures, program modules, and/or other data for computer system 1100. In one example, software 1120 may reside, completely or partially, within machine-readable medium 1128. In another example, software 1120 may reside, completely or partially, within processor 1104.

Computer system 1100 may also include an input device 1132. In one example, a user of computer system 1100 may enter commands and/or other information into computer system 1100 via input device 1132. Examples of an input device 1132 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1132 may be interfaced to bus 1112 via any of a variety of interfaces (not shown) including, but not limited to, a serial interface, a parallel interface, a game port, a USB interface, a FIREWIRE interface, a direct interface to bus 1112, and any combinations thereof. Input device 1132 may include a touch screen interface that may be a part of or separate from display 1136, discussed further below. Input device 1132 may be utilized as a user selection device for selecting one or more graphical representations in a graphical interface as described above.

A user may also input commands and/or other information to computer system 1100 via storage device 1124 (e.g., a removable disk drive, a flash drive, etc.) and/or network interface device 1140. A network interface device, such as network interface device 1140, may be utilized for connecting computer system 1100 to one or more of a variety of networks, such as network 1144, and one or more remote devices 1148 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1144, may employ a wired and/or a wireless mode of communication. In general, any network topology may be used. Information (e.g., data, software 1120, etc.) may be communicated to and/or from computer system 1100 via network interface device 1140.

Computer system 1100 may further include a video display adapter 1152 for communicating a displayable image to a display device, such as display device 1136. Examples of a display device include, but are not limited to, a liquid crystal display (LCD), a cathode ray tube (CRT), a plasma display, a light emitting diode (LED) display, and any combinations thereof. Display adapter 1152 and display device 1136 may be utilized in combination with processor 1104 to provide graphical representations of aspects of the present disclosure. In addition to a display device, computer system 1100 may include one or more other peripheral output devices including, but not limited to, an audio speaker, a printer, and any combinations thereof. Such peripheral output devices may be connected to bus 1112 via a peripheral interface 1156. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve apparatuses and methods according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An apparatus for pluggable inter-chip optical coupling, wherein the apparatus comprises:
a first sub-assembly, wherein the first sub-assembly comprises:
at least a first photonic chip in communication with an optical source, wherein the at least a first photonic chip comprises one or more passive optical elements;
a first high tolerance grating coupler element configured to interface with at least a second photonic chip; and
a first set of one or more alignment features; and
a second sub-assembly, wherein the second sub-assembly comprises:
the at least a second photonic chip, wherein the at least a second photonic chip comprises a sensing region;
a second high tolerance grating coupler element configured to interface with the at least a first photonic chip; and
a second set of one or more alignment features, wherein the second set of one or more alignment features are configured to engage the first sub-assembly at the first set of one or more alignment features, wherein attaching the first sub-assembly to the second sub-assembly using the first set of alignment features and the second set of alignment features aligns the first high tolerance grating coupler in optical communication with the second high tolerance grating coupler.

2. The apparatus of claim 1, wherein:
the first high tolerance grating coupler comprises:
a 300 μm aperture; and
a 9 mm working distance; and
the second high tolerance grating coupler comprises:
a 300 μm aperture; and
a 9 mm working distance.

3. The apparatus of claim 1, wherein:
the first high tolerance grating coupler comprises at least a first reflector, wherein the at least a first reflector is configured to recycle lost light back into the first high tolerance grating coupler; and
the second high tolerance grating coupler comprises at least a second reflector, wherein the at least a second reflector is configured to recycle lost light back into the second high tolerance grating coupler.

4. The apparatus of claim 1, wherein:
the at least a first reflector comprises a multi-layer Distributed Bragg Reflector; and
the at least a second reflector comprises a multi-layer Distributed Bragg Reflector.

5. The apparatus of claim 1, wherein:
the first sub-assembly further comprises a first edge coupler, wherein the first edge coupler is configured to convey light from the at least a first photonic chip to the first high tolerance grating coupler; and
the second sub-assembly further comprises a second edge coupler, wherein the second edge coupler is configured to convey light from the at least a first photonic chip to the first high tolerance grating coupler.

6. The apparatus of claim 1, wherein:
the first set of one or more alignment features comprises:
one or more chip to fixture alignment features; and
one or more fixture to fixture alignment features; and
the second set of one or more alignment features comprise:
one or more chip to fixture alignment features; and
one or more fixture to fixture alignment features.

7. The apparatus of claim 1, wherein the second sub-assembly further comprises an opto-fluidic second sub-assembly comprising a plurality of microfluidic components.

8. The apparatus of claim 1, wherein the optical source comprises a distributed feedback laser.

9. The apparatus of claim 1, wherein the optical source comprises a vertical cavity semiconductor laser.

10. The apparatus of claim 1, wherein the optical source comprises a Vernier-tuned distributed Bragg reflector laser.

11. The apparatus of claim 1, wherein:
the first set of one or more alignment features comprise one or more trenches, wherein the one or more trenches comprise one or more oxide open trenches; and
the second set of one or more alignment features comprise one or more trenches, wherein the one or more trenches comprise one or more of oxide open trenches.

12. The apparatus of claim 1 wherein:
the first set of one or more alignment features comprise one or more trenches, wherein the one or more trenches comprise one or deep trenches; and
the second set of one or more alignment features comprise one or more trenches, wherein the one or more trenches comprise one or more deep trenches.

13. The apparatus of claim 1, wherein:
the first set of one or more alignment features comprise one or more trenches, wherein the one or more trenches comprise one or more thru silicon trenches; and
the second set of one or more alignment features comprise one or more trenches, wherein the one or more trenches comprise one or more thru silicon trenches.

14. The apparatus of claim 1, wherein:
the first sub-assembly further comprises:
a first top mechanical fixture; and
a first bottom mechanical fixture; and
the second sub-assembly further comprises:
a second top mechanical fixture; and
a second bottom mechanical fixture.

15. The apparatus of claim 14, wherein the first top mechanical fixture and the first bottom mechanical fixture are configured to fit together with the second top mechanical fixture and the second bottom fixture through a press-fit connection.

16. The apparatus of claim 1, wherein the first top mechanical fixture, the first bottom mechanical fixture, the second top mechanical fixture, and the second bottom mechanical fixture are machined using one or more materials comprising thermoplastics, metals, and ceramics.

17. A method of manufacturing an apparatus for pluggable inter chip optical coupling, wherein the method comprises:
fabricating a first sub-assembly, wherein the first sub-assembly comprises:
forming at least a first photonic chip configured to communicate with an optical source, wherein the at least a first photonic chip comprises:
integrating an optical source; and
forming one or more passive optical elements;
forming a first high tolerance grating coupler element configured optically interface with at least a second photonic chip; and
forming a first set of one or more alignment features;
fabricating a second sub-assembly, wherein the second sub-assembly comprises:
forming at least a second photonic chip, wherein the at least a second photonic chip comprises a sensing region;
forming a second high tolerance grating coupler element configured to optically interface with the at least a first photonic chip; and
forming a second set of one or more alignment features configured to engage with the first set of alignment features to facilitate optical coupling; and
assembling the first sub-assembly and the second sub-assembly by aligning the first set of alignment features with the second set of alignment features to establish optical communication between the first high tolerance grating coupler element and the second high tolerance grating coupler element.

18. The method of claim 17, wherein:
forming a first set of one or more alignment features comprises forming one or more alignment trenches; and
forming a second set of one or more alignment features comprises forming one or more alignment trenches.

19. The method of claim 17, further comprising:
forming a first top mechanical fixture and a first bottom mechanical fixture in the first sub-assembly; and
forming a second top mechanical fixture and a second bottom mechanical fixture in the second sub-assembly.

20. The method of claim 17, wherein assembling the first sub-assembly and the second sub-assembly comprises joining the first top mechanical fixture and the first bottom mechanical fixture with the second top mechanical fixture and the second bottom mechanical fixture using a press-fit connection.
